(19) United States
(12) Patent Application Publication
(10) Pub. No.: US 2025/0137829 A1
(43) Pub. Date: May 1, 2025

(54) WATER MONITORING AND CONTROL SYSTEM AND PROCESS FOR DETERMINING DISCHARGE AND RECIRCULATION VOLUMES AND FLOW RATES

(71) Applicant: Flowlink Environmental Inc., Coquitlam (CA)

(72) Inventors: Elena RANYUK, Coquitlam (CA); Guillaume LANGLOIS, Coquitlam (CA); Thomas E G HAYES, Coquitlam (CA)

(73) Assignee: Flowlink Environmental Inc., Coquitlam (CA)

(21) Appl. No.: 18/494,313

(22) Filed: Oct. 25, 2023

(51) Int. Cl. G01F 15/075; E03B 7/07

(52) U.S. Cl. CPC G01F 15/0755; E03B 7/071

(57) ABSTRACT

There is provided a water monitoring and control system including a valve assembly configured to receive fluid outputted from a worksite and recirculate/discharge the fluid based on one or more predetermined conditions. A data acquisition system obtains data indicative in real-time of valve positioning, the flow rate of fluid outputted from the worksite and the incremental volume of fluid outputted from the worksite, with discharge and recirculation flow rates and total discharge and recirculation volumes being determinable therefrom.

There is provided a process comprising: discharging/recirculating the fluid based on predetermined conditions; obtaining data in real-time indicative of valve positioning, the flow rate of said fluid upstream of the valve assembly via a flow meter and the incremental volume of fluid passing through the flow meter; and using said data to determine the discharge and recirculation flow rates and the total volume of discharge and recirculation of said fluid.

### BACKGROUND OF THE INVENTION

### Field of the Invention

There is provided a water monitoring and control system and process. In particular, there is provided a water monitoring and control system and process for determining discharge and recirculation volumes and flow rates.

### Description of the Related Art

Referring to FIG. 1, water monitoring and control systems 20 for a worksite 22 may receive effluent or influent 24 that flows intermittently and/or dynamically due to pump cycling on/off. The intermittent nature of the flow may also be caused by and/or depend on one or more of the site condition, development/construction stage, water/runoff quality, environmental considerations (e.g. ground type, rain fall amount/frequency etc.) and the like. Water monitoring and control systems of the known prior art may accordingly periodically direct fluid outputted from worksite 22 via respective valves 32 and 34 of valve assembly 30 to either a discharge conduit 26 where the fluid meets one or more predetermined threshold conditions (e.g. pH levels, turbidity levels etc.) or a recirculation conduit 28 where the fluid does not meet the one or more predetermined threshold conditions. It may also be common for there to be a high frequency of valve switching relative to the data acquisition rate of water quality data and the like. Such systems of the known prior art may accordingly include a first flow meter 36 connected to discharge conduit 26 and via which is determined discharge flow rate 38 and discharge volume 40. Such systems may also include a second flow meter 42 connected to recirculation conduit 28 and via which is determined recirculation flow rate 44 and recirculation volume 46.

There may be a need for a water monitoring and control system that determines discharge and recirculation flow rates, total volume of discharge of influent and total volume of recirculation of influent that takes into account the above dynamic environment so as to obtain accurate/precise data on the one hand, while being more cost-effective and/or compact on the other hand.

### BRIEF SUMMARY OF INVENTION

There is provided, and it is an object to provide, an improved water monitoring and control system disclosed herein.

There is accordingly provided a water monitoring and control system according to one aspect. The water monitoring and control system includes a valve assembly configured to receive fluid outputted from a worksite and recirculate/discharge the fluid based on one or more predetermined conditions. The water monitoring and control system includes a data acquisition system which obtains data indicative in real-time of valve positioning, the flow rate of fluid outputted from the worksite and the incremental volume of fluid outputted from the worksite, with discharge and recirculation flow rates and total discharge and recirculation volumes being determinable therefrom.

There is additionally provided a water monitoring and control system according to a further aspect. The water monitoring and control system includes a flow meter configured to measure fluid outputted from a worksite. The water monitoring and control system includes a valve assembly. The valve assembly includes an inlet in fluid communication with the flow meter, a discharge outlet and a recirculation outlet. The water monitoring and control system includes discharge and recirculation conduits in fluid communication with respective ones of the outlets of the valve assembly. The water monitoring and control system includes an apparatus which outputs an indication of valve positioning of the valve assembly. The water monitoring and control system includes a processor in communication with the flow meter and the apparatus. The processor is configured based thereon to determine discharge and recirculation flow rates of the fluid through the discharge and the recirculation conduits, a total discharge volume of said fluid passing through the discharge conduit and a total recirculation volume of said fluid passing through the recirculation conduit.

There is also provided a water monitoring and control system according to another aspect. The water monitoring and control system includes a flow meter configured to measure fluid outputted from a worksite. The water monitoring and control system includes a valve assembly. The valve assembly includes an inlet in fluid communication with the flow meter. The water monitoring and control system includes discharge and recirculation outlets selectively in communication with the inlet thereof based on valve positioning thereof. The water monitoring and control system includes discharge and recirculation conduits in fluid communication with the discharge and recirculation outlets, respectively. The water monitoring and control system includes an apparatus which outputs an indication of the valve positioning of the valve assembly. The water monitoring and control system includes a processor configured to determine the flow rates and total volume of the fluid passing through the discharge and recirculation conduits based on: said valve positioning as indicated by said apparatus, the flow rate of fluid passing through the flow meter and the incremental volume of fluid passing through the flow meter.

There is further provided a water monitoring and control system according to a further aspect. The water monitoring and control system includes a flow meter configured to measure fluid outputted from a worksite. The water monitoring and control system includes a valve assembly. The valve assembly includes an inlet in fluid communication with the flow meter and a pair of outlets selectively in fluid communication with the inlet thereof. The water monitoring and control system includes discharge and recirculation conduits in fluid communication with respective ones of said outlets of the valve assembly. The water monitoring and control system includes a data acquisition system. The data acquisition system is configured to obtain data indicative in real-time of valve positioning, the flow rate of fluid passing through the flow meter and the incremental volume of fluid passing through the flow meter. The data acquisition system is configured to transmit said data to a processor from which is determined the flow rates and total volume of fluid passing through both said conduits.

There is yet also provided a water monitoring and control system according to another aspect. The water monitoring and control system includes a first conduit configured to receive fluid outputted from a worksite. The water monitoring and control system includes a second conduit configured to discharge said fluid from the first conduit. The water monitoring and control system includes a third conduit configured to recirculate said fluid from the first conduit back towards the site. The water monitoring and control system includes a valve assembly operatively connecting together the first and second conduits and the first and third conduits. The water monitoring and control system includes a processor which determines flow rates and total volume of the fluid passing through the second and third conduits, respectively, based on valve positioning and the flow rate and incremental flow of fluid passing through the first conduit.

There is yet further provided a water monitoring and control system according to an additional aspect. The water monitoring and control system consist of: a first conduit configured to receive fluid outputted from a worksite; a flow meter operatively connected to the first conduit; a second conduit configured to discharge said fluid from the first conduit; a third conduit configured to recirculate said fluid from the first conduit back towards the site; a valve assembly operatively connecting together the first and second conduits and the first and third conduits; and an apparatus which outputs an indication of valve positioning of the valve assembly.

There is additionally provided a water monitoring and control system according to yet another aspect. The water monitoring and control system includes a first conduit configured to receive fluid outputted from a worksite. The water monitoring and control system includes a second conduit configured to discharge said fluid from the first conduit. The water monitoring and control system includes a third conduit configured to recirculate said fluid from the first conduit back towards the site. The water monitoring and control system includes a valve assembly operatively connecting together the first and second conduits and the first and third conduits. The water monitoring and control system includes a measurement assembly via which data indicative of flow rates and total volume of fluid passing through each said conduit is obtained. The assembly comprises or consists of i) a flow meter operatively connected to the first conduit; and ii) an apparatus which outputs an indication of valve positioning of the valve assembly.

There is further provided a water monitoring and control system according to another aspect. The water monitoring and control system includes a first conduit configured to receive fluid outputted from a worksite. The water monitoring and control system includes a second conduit configured to discharge said fluid from the first conduit. The water monitoring and control system includes a third conduit configured to recirculate said fluid from the first conduit back towards the site. The water monitoring and control system includes a valve assembly operatively connecting together the first and second conduits and the first and third conduits. The water monitoring and control system includes a flow and volume assembly via which flow rates and total volume of fluid passing through each said conduit are determined. The assembly comprises or consists of i) a flow meter operatively connected to the first conduit; ii) an apparatus which outputs an indication of valve positioning of the valve assembly; and iii) a processor in communication with said flow meter and said apparatus.

There is yet also provided a water monitoring and control system for fluid outputted from a worksite and which is discharged or recirculated via a valve assembly. The water monitoring and control system includes an apparatus configured to output data indicative in real-time of i) the total volume and the current flow rate of the fluid upstream of and/or entering the valve assembly, ii) the current position of the valve assembly, and iii) a start time at which of the valve assembly changed from a prior position to the current position thereof. The water monitoring and control system includes a processor configured to receive said data and determine therefrom: the change in volume between the current and previous total volume of said fluid; the current discharge flow rate; the change in discharge volume; the current recirculation flow rate; and the change in recirculation volume.

There is additionally provided a water monitoring and control process according to one aspect. The water monitoring and control process includes monitoring fluid outputted from a worksite. The water monitoring and control process includes determining whether said fluid satisfies one or more predetermined conditions and based thereon actuating a valve assembly to either discharge the fluid from the worksite or recirculate the fluid to the worksite. The water monitoring and control process includes obtaining data indicative in real-time of valve positioning of the valve assembly, the flow rate of said fluid via a flow meter upstream of the valve assembly, and the incremental volume of fluid passing through the flow meter. The water monitoring and control process includes determining via a processor and based on said data, discharge and recirculation flow rates and the total volume of discharge and recirculation of said fluid.

There is also provided a water monitoring and control system accordingly to another aspect. The water monitoring and control system includes discharge and recirculation conduits and a valve or valve assembly positioned therebetween. The water monitoring and control system includes a single flow meter positioned upstream of valve or said valve assembly. The water monitoring and control system includes a processor which determines the flow rate and total volume of both conduits based on valve position, flow rate from the flow meter and the incremental volume of the flow meter.

There is further provided a water monitoring and control process according to a further aspect. The water monitoring and control process includes discharging fluid from a worksite which satisfies one or more predetermined conditions via a valve assembly. The water monitoring and control process includes recirculating fluid to the worksite which fails to satisfy the one or more predetermined conditions via the valve assembly. The water monitoring and control process includes obtaining data in real-time indicative of valve positioning of the valve assembly, the flow rate of said fluid upstream of the valve assembly via a flow meter and the incremental volume of fluid passing through the flow meter. The water monitoring and control process includes determining via a processor and based on said data, discharge and recirculation flow rates and the total volume of discharge and recirculation of said fluid.

There is also provided a water monitoring and control process according to a further aspect. The water monitoring and control process includes measuring fluid outputted from a worksite via a flow meter. The water monitoring and control process includes selectively discharging or recirculating said fluid via a valve assembly downstream of the flow meter. The water monitoring and control process includes acquiring data indicative in real-time of valve positioning, the flow rate of said fluid passing through the flow meter and the incremental volume of said fluid passing through the flow meter. The water monitoring and control process includes determining discharge and recirculation flow rates and the total volume of discharge and recirculation of said fluid based on said data.

There is further provided a water monitoring and control process according to another aspect for fluid outputted from a worksite and which is discharged or recirculated via a valve assembly. The water monitoring and control process includes obtaining in real-time the current position of the valve assembly, the change of volume of the fluid passing through the valve assembly and the current flow rate of the fluid entering the valve assembly. The water monitoring and control process includes determining via a processor whether the current position of the valve assembly is a discharge position and whether the valve assembly was in the discharge position in a previous measurement of the position of the valve assembly and if so, determining that the change of volume of the fluid is the change of discharge volume and that the current flow rate of the fluid is the current discharge flow rate. The water monitoring and control process includes determining via the processor whether the current position of the valve assembly is a recirculation position and whether the valve assembly was in the recirculation position in the previous measurement of the position of the valve assembly and if so, determining that the change of volume of the fluid is the change of recirculation volume and that the current flow rate of the fluid is the current recirculation flow rate.

There is yet further provided a water monitoring and control process according to an additional aspect for fluid outputted from a worksite and which is discharged or recirculated via a valve assembly. The water monitoring and control process includes obtaining in real-time the position of the valve assembly, a start time at which of the valve assembly last changed position, the change of volume of said fluid passing through the valve assembly and the current flow rate of said fluid entering the valve assembly. The water monitoring and control process includes determining whether the valve assembly is changing direction at the current measurement of the position of the valve assembly and if so, shifting an equation describing a closure pattern of the valve assembly horizontally to match the start time. If the valve assembly is determined to not be changing direction at the current measurement of the position of the valve assembly, the water monitoring and control process includes determining whether the valve assembly has changed direction since a last measurement of the position of the valve assembly and if so, shifting the equation describing the closure pattern of the valve assembly horizontally to match the start time. The water monitoring and control process includes calculating the current discharge and recirculation flow rates and calculating the change in discharge and recirculation volume based thereon.

There is also provided use of a single flow meter measuring in real-time fluid outputted from a worksite, together with real-time measurement of positioning of a valve assembly via which the fluid is discharge or recirculated, for determining discharge and recirculation flow rates of the fluid, a total discharge volume of said fluid and a total recirculation volume of said fluid.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a schematic flow diagram of influent analyzed by a water monitoring and control system of the prior art, in which the water monitoring and control system directs the influent to either be discharged or re-circulated based on water quality thereof;

FIG. 2 is a schematic flow diagram of the processing of influent through a water treatment system so as to output an effluent, together with a water monitoring and control system according to one aspect, with the water monitoring and control system analyzing the effluent so outputted and based on the same directing the effluent to either be discharged or re-circulated back to the influent or any other collection point;

FIG. 3 is a schematic flow diagram similar to FIG. 2 without a water treatment system, where influent is analyzed by the water monitoring and control system of FIG. 2 and directed to either be discharged or re-circulated based on water quality thereof;

FIG. 4 is a schematic flow diagram of the water monitoring and control system of FIG. 2 or 3 receiving effluent/influent therethrough, with the water monitoring and control system including a valve assembly in the form of a pair of valves via which the effluent/influent is discharged or recirculated, together with a single flow meter upstream of the valve assembly and a software-based dynamic flow processor in communication with the single flow meter and the valve assembly or positioning thereof, so as to determine discharge flow rate, total discharge volume, recirculation flow rate and total recirculation volume;

FIG. 5 is a schematic flow diagram of a data acquisition system thereof and via which is obtained data indicative in real-time of valve positioning, the flow rate of fluid passing through the single flow meter and the incremental volume of fluid passing through the single flow meter, together a processor and software which are off-site and which receive said data and based thereon, determine the discharge flow rate, the total discharge volume, the recirculation flow rate and the total recirculation volume of fluid;

FIG. 6 is an algorithm according to one aspect for determining discharge flow rate, total discharge volume, recirculation flow rate and total recirculation volume for any of water monitoring and control systems of any of FIGS. 2 to 5;

FIG. 7 is an algorithm according to another aspect for determining discharge flow rate, total discharge volume, recirculation flow rate and total recirculation volume for any of water monitoring and control systems of any of FIGS. 2 to 5;

FIG. 8 is a graph illustrating an example of a valve closure pattern of the valve assembly of FIGS. 2 to 5 shown in solid lines, together with a corresponding valve closure pattern shown in stippled lines which has been shifted by the water monitoring and control system of any of FIGS. 2 to 7 to align with a transition start time of the valve assembly;

FIG. 9 is a schematic flow diagram similar to FIG. 4 of a water monitoring and control system according to another aspect, in which the valve assembly comprises a three-way valve; and

FIG. 10 is a schematic flow diagram similar to FIG. 5 according to another aspect, in which the processor and software are situated on-site locally with and/or adjacent the data acquisition system.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

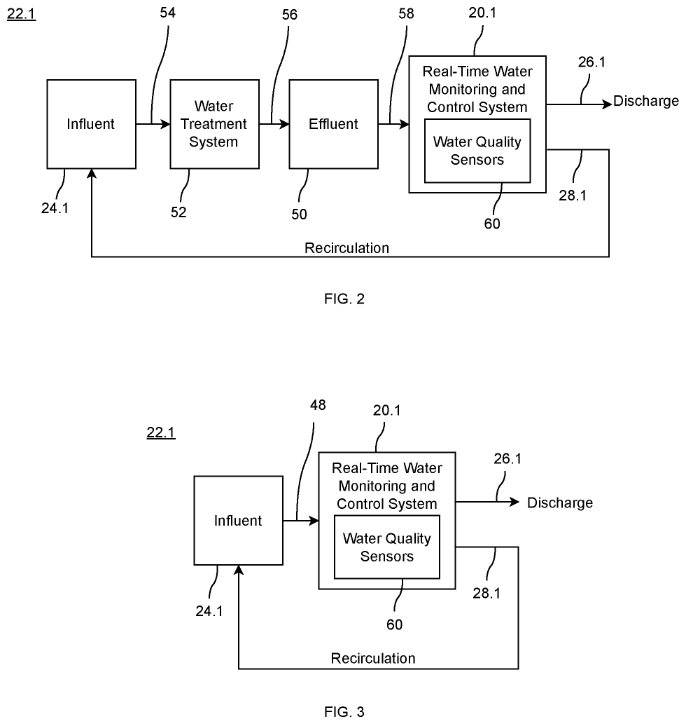

Referring to the drawings and first to FIG. 2, there is shown a water monitoring and control system 20.1. The water monitoring and control system is configured to operate in real-time in this example and may thus be referred to as a real-time water monitoring and control system.

Water monitoring and control system 20.1 is configured to receive fluid outputted from a worksite 22.1, which in this non-limiting embodiment is a development or construction site. The fluid outputted from worksite 22.1 in this example has an intermittent flow, though this is not strictly required. Water monitoring and control system 20.1 is thus configured to receive an intermittent flow of fluid outputted from the worksite in this non-limiting embodiment.

As seen in FIG. 3, the fluid may comprise influent 24.1 (runoff, wastewater or the like), with water monitoring and control system 20.1 being directly downstream and in fluid communication thereof via conduit 48. Alternatively and as seen in FIG. 2, the fluid may comprise effluent 50. In this case a water treatment system 52 is provided downstream of influent 24.1, with the water treatment system being in fluid communication with the influent via conduit 54.

In the embodiment shown in FIG. 2, the water treatment system is configured to treat the influent and output effluent 50. Water treatment system 52.1 may include and/or involve, for example, adding one or more chemicals or ingredients to lower/raise the pH and/or lower turbidity levels of influent 24.1 so as to output effluent that meets or more closely meets regulatory requirements and/or water specifications which need to be met prior to the fluid leaving worksite 22.1. Water monitoring and control system 20.1 may be connectable to, in fluid communication with and downstream of water treatment system 52 via one or more conduits 56 and 58. The water monitoring and control system is thus configured to receive effluent 50 in this non-limiting embodiment.

Alternatively, water treatment system 52 may be said to be a part of water monitoring and control system 20.1. Either of conduits 48 or 54/56 seen in FIGS. 2 and 3 may be referred to as a first conduit configured to receive therethrough fluid outputted from worksite 22.1, with the water monitoring and control system thus being connectable to or including said first conduit. Water treatment system 52 seen in FIG. 2 may be a third party and/or off-the-shelf system. Water treatment systems per se, including their various parts and functionings, are known and water treatment system 52 will accordingly not be described in further detail.

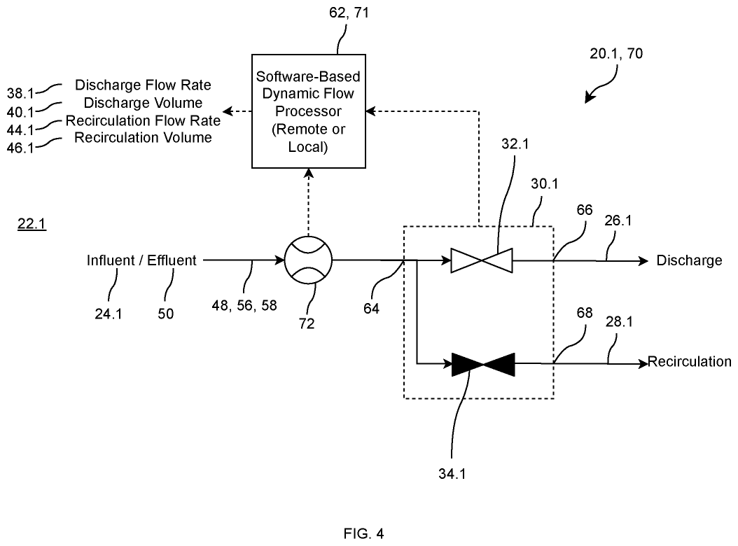

Water monitoring and control system 20.1 includes or is connectable one or more sensors, in this example water quality sensors 60. The water quality sensors are configured to measure in real-time properties of effluent 50 in FIG. 2 or influent 24.1 in FIG. 3, outputted from worksite 22.1 and output data indicative thereof. As seen in FIG. 4, water monitoring and control system 20.1 includes a processor 62 configured to receive said data and determine whether the fluid satisfies one or more predetermined conditions based thereon. The latter may involve regulatory requirements and may include determining whether the fluid is equal to or below prescribed pH levels, turbidity levels and the like for a predetermined amount of time and/or taking into account recent rain levels and the like. Additional non-limiting particulars in this regard are described in U.S. patent application Ser. No. 18/162,267 filed in the United States Patent and Trademark Office on 31 Jan. 2023, and the disclosure of which is incorporated herein by reference and priority to which is claimed.

As seen in FIG. 4, water monitoring and control system 20.1 includes a valve assembly 30.1. The valve assembly includes an inlet 64 operatively connected to, in fluid communication with and configured to receive fluid or influent/effluent 24.1/50 passing through conduit 48/56/58. Valve assembly 30.1 includes a discharge outlet 66 and a recirculation outlet 68, each selectively in communication with the inlet thereof based on valve positioning thereof. The valve assembly may comprise one or more solenoid valves; however, this is not strictly required. Valve assembly 30.1 in this non-limiting embodiment includes a first valve, in this example discharge valve 32.1 in fluid communication with inlet 64 and discharge outlet 66 thereof. Actuation of the discharge valve enables discharging of influent/effluent 24.1/50 that meets one or more predetermined conditions as determined by water monitoring and control system 20.1. Valve assembly 30.1 in this non-limiting embodiment includes a second valve, in this example a recirculation valve 34.1. Actuation of the recirculation valve promotes recirculation of influent/effluent 24.1/50 that does not meet one or more predetermined conditions, back to worksite 22.1.

Valve assembly 30.1 includes a controller, in this non-limiting example in the form of processor 62, via which valves 32.1 and 34.1 may be selectively actuated or moved between various states. The processor may, but need not necessarily, be a part of the controller. In other embodiments, the controller of valve assembly 30.1 is separate from processor 62. The states of the valve assembly include a discharge position in which fluid passing through inlet 64 of the valve assembly is directed to discharge outlet 66 and inhibited from exiting out of recirculation outlet 68. In the discharge position of valve assembly 30.1, discharge valve 32.1 is actuated or in an at least partially or fully open position and recirculation valve 34.1 is in an at least partially or fully closed position.

Still referring to FIG. 4, water monitoring and control system 20.1 is connectable to or includes a second or discharge conduit 26.1. The discharge conduit is in fluid communication with and downstream of discharge outlet 66 of valve assembly 30.1. Discharge conduit 26.1 in this non-limiting embodiment operatively connects, is in fluid communication with and is downstream of discharge valve 32.1. Influent/effluent 24.1/50 that meets one or more predetermined conditions or water specifications as determined by water monitoring and control system 20.1, is discharged from and taken away worksite 22.1 via the discharge conduit.

The states of the valve assembly include a recirculation position in which the fluid passing through inlet 64 is directed to recirculation outlet 68 and inhibited from exiting out of discharge outlet 66. In the recirculation position of valve assembly 30.1, discharge valve 32.1 is in a closed position and recirculation valve 34.1 is in an at least partially or fully open position.

Still referring to FIG. 4, the water monitoring and control system is connectable to or includes a third or recirculation conduit 28.1. The recirculation conduit is in fluid communication with and downstream of recirculation outlet 68 of valve assembly 30.1. Recirculation conduit 28.1 in this non-limiting embodiment operatively connects, is in fluid communication with and is downstream of discharge valve 32.1. Influent/effluent 24.1/50 that fails to meet one or more predetermined conditions or water specifications as determined by water monitoring and control system 20.1, is recirculated back to water treatment system 52 and/or worksite 22.1 seen in FIGS. 2 and 3 via the recirculation conduit. Referring back to FIG. 4, valve assembly 30.1 thus selectively operatively connects together conduit 48/56/58 and discharge conduit 26.1, as well as conduit 48/56/58 and recirculation conduit 28.1.

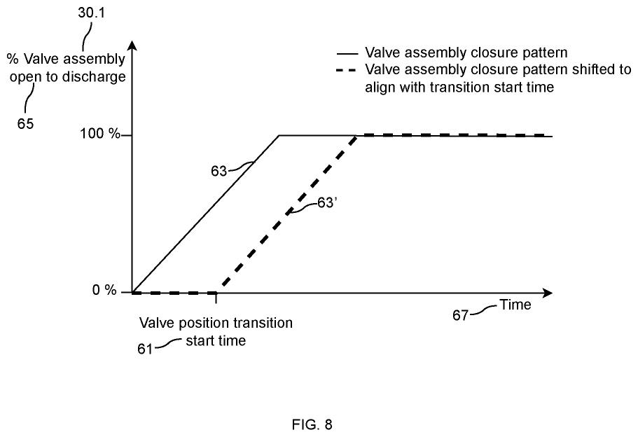

The valve assembly is thus configured to receive influent/effluent 24.1/50 via inlet 64 thereof and direct said fluid from discharge outlet 66 to recirculation outlet 68 and vice versa. Water monitoring and control system 20.1 thus receives fluid outputted from worksite 20.1 and discharges or recirculates the fluid via valve assembly 30.1. In each case, the valve assembly has an actuation duration which may be referred to as the time required for the valve assembly to fully transition or move from one state to another (e.g. the recirculation position to the discharge position or vice versa). As seen in FIG. 8, valve assembly 30.1 has a start time 61 at which the valve assembly begins transitioning from one state to another.

Referring back to FIG. 4, the states of the valve assembly optionally include a fully closed position in which fluid or influent/effluent 24.1/50 entering inlet 64 is inhibited from passing through either of outlets 66 and 68; however, this state may not strictly be required. In the fully closed position of valve assembly 30.1, both discharge valve 32.1 and recirculation valve 34.1 are in closed positions.

As seen in FIG. 8, valve assembly 30.1 includes a valve assembly closure pattern or valve closure pattern 63. The valve closure pattern is indicative of the extent to which the valve assembly is open 65 to discharge fluid via discharge outlet 66 seen in FIG. 4 as a function time 67 while the valve assembly moves from recirculate to discharge positions. In addition or alternatively, valve closure pattern 63 seen in FIG. 8 may be indicative of the extent to which valve assembly 30.1 is open to recirculate fluid via recirculation outlet 68 1 seen in FIG. 4 as a function time while the valve assembly moves from discharge to recirculation positions.

Water monitoring and control system 20.1 includes an algorithm or equation stored in memory 71 thereof seen in FIG. 4 and which describes or approximates the valve closure pattern. The algorithm may be configured to estimate more accurately the flow in each conduit 26.1 and 28.1 while valves 32.1 and 34.1 are changing position. The algorithm may be configured to estimate more accurately the extent of fluid or influent/effluent 24.1/50 passing through valve assembly 30.1 during a change of state thereof. The algorithm/equation is configured to estimate the flow exiting each outlet 66 and 68 of the valve assembly while the valve assembly is changing position i.e. when the valve assembly is actuated to move from the recirculation position thereof towards the discharge position thereof or vice versa.

Valve closure pattern 63 (or the equation related thereto) seen in one non-limiting embodiment in FIG. 8, may obtained in multiple ways. For example, the valve closure pattern (or the equation related thereto) may be calculated for certain types of valves. For instance, the closure pattern of two butterfly valves may be linear and thus readily calculated as long as the actuation duration is known, whether from manufacturer specifications or determined empirically. Valve closure pattern 63 (or the equation related thereto) may be determined via computational fluid dynamics simulations in another non-limiting example. In addition or alternatively, the valve closure pattern (or the equation related thereto) may be determined empirically via temporary use of a second said flow meter downstream of valve assembly 30.1 seen in FIG. 4 for example.

In operation and referring to FIG. 4, valve assembly 30.1 may be in a default closed or recirculation position so as to inhibit influent/effluent 24.1/50 from exiting worksite 22.1. Water monitoring and control system 20.1 measures/tests the quality of the influent/effluent via one or more water quality sensors 60 seen in FIGS. 2 and 3 and outputs data in real-time indicative of the properties of the influent/effluent to processor 62 seen in FIG. 4. The processor analyzes said data to determine whether influent/effluent 24.1/50 satisfies one or more predetermined conditions based thereon and if so, the processor (and/or a valve controller) is configured to actuate valve assembly 30.1 from the closed or recirculation position to the discharge position to discharge the fluid from worksite 22.1 via discharge conduit 26.1. The discharge conduit is thus so configured to discharge the fluid from conduit 48/56/58.

If influent/effluent 24.1/50 does not satisfy one or more predetermined conditions as determined by processor 62, the fluid is not in a condition for discharge and valve assembly 30.1 is positioned via the processor (and/or valve controller) to the closed position or recirculation position. This causes influent/effluent 24.1/50 to recirculate via recirculation conduit 28.1 to worksite 22.1 and/or water treatment system 52 seen in FIG. 2 for further water treatment until the condition of the fluid has been improved. The recirculation conduit is thus so configured to recirculate the fluid from conduit 48/56/58 back towards worksite 22.1 and/or water treatment system 52. In addition or alternatively, if influent/effluent 24.1/50 does not satisfy one or more predetermined conditions as determined by processor 62 and the fluid is not in a condition for discharge, valve assembly 30.1 may be positioned via processor 62 (and/or valve controller) to its fully closed position in which fluid is inhibited from passing through the valve assembly. Valve assembly 30.1 is thus configured to selectively i) promote passage of the fluid to discharge conduit 26.1; ii) promote passage of the fluid to recirculation conduit 28.1; or iii) inhibit passage of the fluid to either the discharge conduit or recirculation conduit.

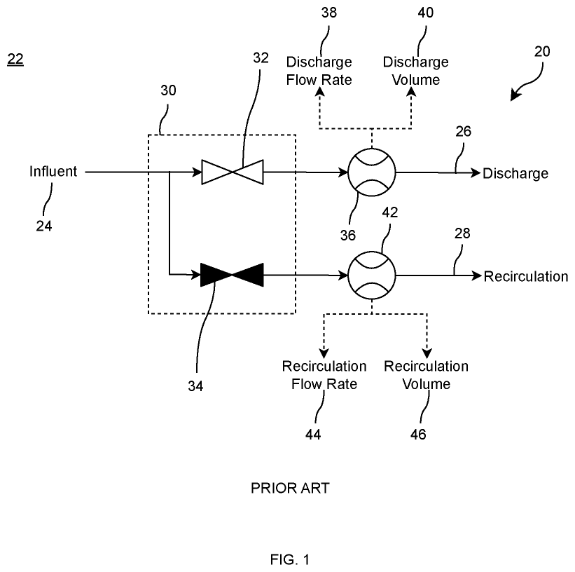

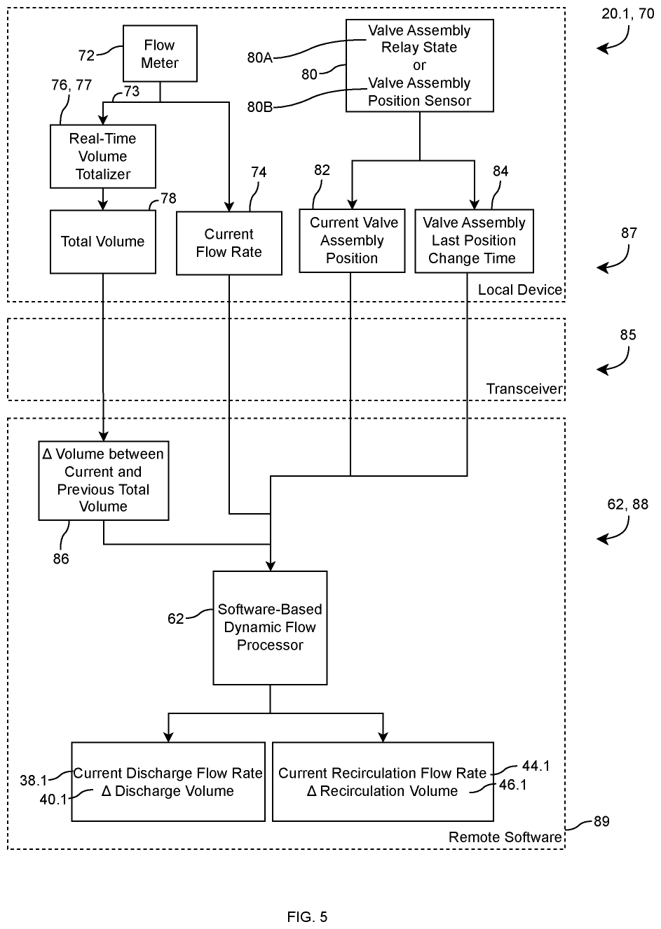

Referring to FIG. 5, water monitoring and control system 20.1 includes a measurement assembly, in this non-limiting embodiment in the form of a remote data acquisition system 70. The data acquisition system is configured to obtain data indicative of flow rates and total volume of fluid passing through discharge conduit 26.1 and recirculation 28.1 seen in FIG. 4. Referring back to FIG. 5, data acquisition system 70 includes a device configured to output data indicative in real-time of the total volume and the current flow rate of the fluid entering into and/or upstream of the valve assembly, in this example in the form of only one or a single flow meter 72. The single flow meter is operatively connected to and/or in fluid communication with conduits 48/56/58 seen in FIG. 4. Water monitoring and control system 20.1 thus consists of only said single flow meter and does not directly monitoring discharge/recirculation flow nor does the system include one or more additional flow meters associated with the discharge and recirculation conduits, such flow meters 36 and 42 for conduits 26 and 28 seen in FIG. 1. Referring back to FIG. 4, flow meter 72 may comprise or be referred to as a flow meter and/or be configured to measure fluid that has dynamic flow properties. The flow rate and incremental flow of fluid passing through conduit 48/56/58 are dynamic and measured in real-time via the flow meter. Processor 62 in this non-limiting embodiment may likewise comprises a dynamic flow said processor.

Flow meter 72 is upstream of valve assembly 30.1 in this example. The flow meter is positioned downstream of water treatment system 52 seen in FIG. 2 where water monitoring and control system 20.1 connects or includes the same; however, this example is not strictly required. Referring back to FIG. 4, the flow meter in this non-limiting embodiment is configured to be interposed between the valve assembly and the water treatment system.

Flow meter 72 operatively couples to conduit 48/56/58 so as to measure the flow rate 74 of influent/effluent 24.1/50 passing therethrough and the incremental volume of influent/effluent passing therethrough. The flow meter is thus configured to measure fluid outputted from worksite 22.1 and/or water treatment system 52 seen in FIG. 2. Referring back to FIG. 4, inlet 64 of valve assembly 30.1 is in fluid communication with flow meter 72.

As seen in FIG. 5, water monitoring and control system 20.1 (or flow meter 72 thereof) in this example includes a totalizer 76. The totalizer is configured to measure a total accumulated volume 78 of fluid passing through the flow meter in real-time. Water monitoring and control system 20.1 may thus be said to comprise a real-time volume said totalizer 76 via which the total volume of the fluid upstream of valve assembly 30.1 seen in FIG. 4 is obtained. Totalizer 76 may thus operate at a high frequency depending on the flow rate of fluid passing therethrough. Referring back to FIG. 5, the totalizer is configured to operate locally on flow meter 72 or on a controller of the valve assembly. Data is fetched remotely with the totalizer being configured to accumulate the flow of the fluid passing the flow meter locally between each data fetch cycle.

Water monitoring and control system 20.1 in this non-limiting embodiment includes a high-speed digital input counter 77. The high-speed digital input counter acquires volume information in the form of a volume per pulse. High-speed digital input counter 77 in this non-limiting example operates in the range of 0 to 500 Hz. Volume totalizer 76 as herein described is configured to accumulate the flow between each data fetch cycle. The total volume is thereafter processed on its own.

Still referring to FIG. 5, data acquisition system 70 includes a valve position sensing apparatus 80. The apparatus is configured to output data indicative of current position 82 of the valve assembly and start time 84 at which of the valve assembly changes from a prior position to the current position thereof. The latter may be referred to as a valve assembly last position change time. Valve position sensing apparatus 80 is locally situated in this example. The valve position sensing apparatus is configured to obtain data indicative of the valve positioning in real-time. Data acquisition system 70 is thus configured to obtain one or more signals or data locally from flow meter 72 and apparatus 80 in real-time.

The valve position sensing apparatus in one non-limiting embodiment may function by analyzing a valve assembly relay state and/or may comprise one or more relays 80A, activation of which controls and/or adjusts positioning of valve assembly 30.1 seen in FIG. 4. Analyzing relay state and/or relay activation as a function of time may provide data acquisition system 70 with data indicative of valve assembly position. Referring back to FIG. 5, the data acquisition system in this non-limiting embodiment may thus be configured to obtain and/or output data indicative of current position 82 of valve assembly and/or start time 84 at which of the valve assembly changed from a prior position to the current position thereof, based on said one or more relay states 80A of the valve assembly.

In addition or alternatively, valve position sensing apparatus 80 may comprise a valve position sensing device, in this example one or more valve sensors and/or valve assembly position sensors 80B. Data acquisition system 70 in this non-limiting embodiment may be configured to obtain and/or output data indicative of current position 82 of the valve assembly and/or start time 84 at which of the valve assembly changes from the prior position to the current position thereof, based on the one or more valve assembly position sensors.

Still referring to FIG. 5, processor 62 is in communication with data acquisition system 70, including flow meter 72 and apparatus 80 thereof. The data acquisition system is configured to i) obtain data indicative in real-time of valve positioning 82, the current flow rate 74 of fluid passing through flow meter 72 and the incremental volume 73 of fluid passing through the flow meter, which via totalizer 76 may be used to determine total volume 78 of fluid passing through the flow meter. Data acquisition system 70 is configured to transmit said data to processor 62 from which is determined by the processor the change in volume between current and previous total volumes 86 of said fluid.

Water monitoring and control system 20.1 in this non-limiting example includes a transceiver 85 via which one or more signals or data 87 from data acquisition system 70 is communicated to processor 62. The processor in this non-limiting embodiment is part of an off-site, central and/or remote server 88, with the data acquisition system being configured to transmit data to the remote server via the transceiver. Processor 62 may be a part of a cloud computing system, with the processor operating via remote and/or cloud-based software 89. Water monitoring and control system 20.1 may thus use an off-site and/or third party said processor 62.

In this non-limiting embodiment, data 87 is acquired locally in real-time via data acquisition system 70 and transmitted to remote server 88 in intervals. The data acquisition system in this non-limiting example is configured to periodically transmit said data to processor 62 at intervals. Data 87 may thus be transmitted to the remote server at predetermined intervals. Each predetermined interval is substantially equal to about one minute in one non-limiting embodiment; however, this is not strictly required and may be a higher or lower interval in other embodiments. Flow meter 72 (and/or totalizer 76 thereof) is configured to be capable of operating locally at one or more frequencies which are higher than the frequency at which processor 62 is executed.

Referring back to FIG. 8, valve closure pattern 63 (or equation thereof) once determined, together with valve actuation time as measured or pre-determined, may be correlated to valve position transition start time 61 and the real-time flow rate(s) of fluid passing through flow meter 72 seen in FIG. 5 during said time(s), to more accurately determine via processor 62 the volume of fluid that is discharged or/or recirculated during the transition of states of the valve assembly, as well as the recirculation and/or discharge flow rates in real-time. The processor as herein described may thus be configured to account for the valve switching error, valve actuation lag-time and/or non-ideal valve switching so as to make a more accurate volume total and flow rate determinations.

Referring to FIGS. 4 and 5, processor 62 is configured to use the data obtained in real-time by data acquisition system 70 to determine:
a. current discharge flow rate 38.1 or discharge flow rate passing through discharge outlet 66 and/or discharge conduit 26.1 (taking into account mass balancing and correlating the flow rate of liquid passing by flow meter 72 with valve position in real-time to so determine the same);
b. the change or total discharge volume 40.1 passing through the discharge outlet and/or discharge conduit (via totalizer 76 which obtains incremental volume in real-time and is later summed taking into account the desired time period and/or time elapsed, and taking into account mass balancing and correlating to valve position in real-time to so determine the same);
c. current recirculation flow rate 44.1 or recirculation flow rate passing through recirculation outlet 68 and/or recirculation conduit 28.1 (taking into account mass balancing and correlating the flow rate of liquid passing by flow meter 72 with valve position in real-time to so determine the same); and
d. the change or total recirculation volume 46.1 passing through the recirculation outlet and/or recirculation conduit (via totalizer 76 which obtains incremental volume in real-time and is later summed taking into account the desired time period and/or time elapsed, and taking into account mass balancing and correlating to valve position in real-time to so determine the same).

Processor 62 incorporates valve closure pattern 63 (or the equation related thereto) seen in FIG. 8 at least in part in determining one or more of: the discharge and recirculation flow rates 38.1 and 44.1 of the fluid through discharge and the recirculation conduits 26.1 and 28.1 seen in FIG. 4, total discharge volume 40.1 of said fluid passing through the discharge conduit and total recirculation volume 46.1 of said fluid passing through the recirculation conduit. The processor is configured to shift the valve closure pattern, or equation related thereto, horizontally, as seen by numeral 63′ in FIG. 8, to match start time 61 at which valve assembly 30.1 transitions from one state to another state and/or from an open to a closed position or vice versa and/or from the discharge position to the recirculation position or vice versa.

Processor 62 determines volume of the fluid passing through the valve assembly during the transition between valve states based on valve closure pattern 63 so shifted. The volume of the fluid passing through valve assembly 30.1 during a transition between valve states may thus be determined via the processor based on the valve closure pattern, the actuation duration of the valve assembly, a determination of start time 61 of said transition, and a shifting of the valve closure pattern to match the start time. Processor 62 may be configured in one non-limiting embodiment to further transform valve closure pattern 63 based on a determination that the actuation duration of the valve assembly has increased due to wear and tear of the valve assembly.

As seen in FIG. 4, processor 62 is thus configured to determine the volume of fluid passing through both conduits 26.1 and 28.1. Referring to FIG. 5, the processor is thus configured to determine the flow rates and total volume of the fluid passing through the discharge and recirculation conduits based on: valve positioning 82 as indicated by apparatus 80, flow rate 74 of fluid passing through flow meter 72 and incremental volume 73 of fluid passing through the flow meter. For the embodiment which includes water treatment system 52 seen in FIG. 2, processor 62 seen in FIG. 5 thus determines approximations of discharge and recirculation flow rates 38.1 and 44.1, total discharge volume 40.1 and total recirculation volume 46.1 based on the valve positioning, an output flow rate of the water treatment system and the incremental volume of the flow meter so determined. Valve position determined in real-time is thus used to calculate recirculation and/or discharge flow rates in discharge and recirculation conduits 26.1 and 28.1, respectively. Data acquisition system 70 thus obtains data 87 locally in real-time and the data is processed and/or stored off-site via processor 62 in this non-limiting embodiment.

As seen in FIGS. 4 and 5, data acquisition system 70 and processor 62 may be referred to collectively as a flow and volume assembly via which flow rates 38.1/44.1 and total volume of fluid 40.1/46.1 passing through each conduit 48/56/58, 26.1, and 28.1 are determined, with the assembly comprising or consisting of i) flow meter 72 operatively connected to conduit 48/56/58; ii) apparatus 80 which outputs an indication of valve positioning 82 of valve assembly 30.1; and iii) the processor in communication with the flow meter and the apparatus.

In operation there is thus accordingly also provided a water monitoring and control process. Referring to FIGS. 2 and 3, the process may include monitoring fluid or influent/effluent 24.1/50 outputted from worksite 22.1, such as for example, by measuring one or more properties of the fluid in real-time via one or more sensors 60.

Referring to FIG. 4, the process may include determining whether the influent/effluent satisfies one or more predetermined conditions and based thereon via water monitoring and control system 20.1 and/or processor 62 and if so, actuating valve assembly 30.1 to either discharge the fluid from worksite 22.1 or recirculate the fluid to the worksite. The process may thus include determining via one or more sensors 60 seen in FIGS. 2 and 3 whether said fluid satisfies one or more predetermined conditions and based thereon, selectively discharging or recirculating said fluid. Referring to FIG. 4, the process may thus include discharging fluid from worksite 22.1 which satisfies one or more predetermined conditions via valve assembly 30.1 and recirculating fluid to the worksite which fails to satisfy the one or more predetermined conditions via the valve assembly. The process may include configuring the valve assembly to direct the flow of the fluid between recirculation and discharge conduits 26.1 and 28.1 or from a first said conduit to a second said conduit and vice versa.

Referring to FIG. 5, the process may include obtaining data indicative in real-time of valve positioning 82 of the valve assembly. This may include obtaining the data indicative of the valve positioning based one or more relays 80A, activation of which causes positioning of valve assembly to be adjusted. Alternatively, this may include obtaining the data indicative of valve positioning 82 based one or more position or valve sensors 80B, for example. However, this is not strictly required: the status (on/off) of the relay(s) controlling the valve assembly (or valve(s) thereof) is sufficient to obtain data indicative of valve positioning in real time. In either case, the process may thus include obtaining in real-time the current position of the valve assembly. Valve position or positioning may thus be obtained from relays 80A or via position/valve sensors 80B.

Referring to FIG. 4, the process may include measuring fluid outputted from worksite 22.1 in real-time via flow meter 72. The process may include positioning the flow meter downstream of water treatment system 52 seen in FIG. 2 for embodiments which include and/or are connectable to a water treatment system. As seen in FIG. 4, the process may include positioning flow meter 72 upstream of valve assembly 30.1 and/or so as to be in fluid communication with and/or operatively connect to inlet 64 of the valve assembly. Referring to FIGS. 2 and 4, the process may include interposing the flow meter between water treatment system 52 and valve assembly 30.1. As seen in FIG. 5, the process may include obtaining or acquiring data indicative in real-time of the flow rate 74 of the fluid or influent/effluent via flow meter 72. The process may include obtaining or acquiring data indicative of incremental volume 73 of fluid passing through the flow meter.

The process may include measuring the total accumulated volume of said fluid passing through of flow meter 72 via totalizer 76 in this example. The process may include fetching the data remotely with the totalizer being configured locally to accumulate the flow of said fluid passing the flow meter between each data fetch cycle. The process may include acquiring volume information from the flow meter via a high-speed digital input counter in the form of a volume per pulse. The process may optionally operating the high-speed digital input counter in the range of 0 to 500 Hz; however, the latter is not strictly required and may be different in other embodiments. The process may include obtaining in real-time the change of volume 86 of the fluid passing through the valve assembly and the current flow rate 74 of the fluid entering the valve assembly.

The process may include acquiring said data 87 locally in real-time. The process may include transmitting the data to processor 62. The process may include in one non-limiting embodiment transmitting the data to a remote and/or off-site central server 88 for processing and/or storage thereof. The process may include in this example transmitting the data 87 obtained in real-time to the remote server in intervals for processing thereof and/or periodically transmitting said data obtained in real-time to processor. The process may thus include in this non-limiting embodiment obtaining said data locally and processing and/or storing said data off-site.

The process may include determining discharge and recirculation flow rates 38.1/44.1 and the total volume of discharge and recirculation 40.1/46.1 of said fluid or influent/effluent based on said data 87. The process includes using processor 62 for said determining. The process may include relying solely on one said flow meter 72 upstream of valve assembly 30.1 seen in FIG. 4, together said valve positioning as obtained via apparatus 80 seen in FIG. 5, to determine the discharge and recirculation flow rates and the total volume of discharge and recirculation of said fluid. The process may thus include measuring only one upstream said flow rate (in this case the flow rate of influent/effluent 24.1/50 entering inlet 64 of valve assembly 30.1 seen in FIG. 4) to determine two downstream said flow rates (discharge and recirculation flow rates 38.1 and 46.1). The process may include using mass balancing at least in part to determine the discharge and recirculation flow rates and/or discharge and recirculation volumes 40.1 and 46.1.

Referring to FIG. 8, the process may include incorporating valve closure pattern 63 of valve assembly 30.1 at least in part in determining one or more of: the discharge and recirculation flow rates 38.1 and 44.1 seen in FIG. 5, the total discharge volume 40.1 of said fluid and the total recirculation volume 46.1 of said fluid. The process may include determining the valve closure pattern via computational fluid dynamics simulations. Alternatively and referring to FIG. 8, the process may include determining valve closure pattern 63 empirically via temporary use of a second said flow meter (not shown) downstream of the valve assembly.

Referring to FIGS. 5 and 8, the process may include shifting the valve closure pattern via processor 62 to match start time 61 at which valve assembly 30.1 transitions from one state to another state. The process may include formulating an equation describing valve closure pattern and shifting the equation horizontally, as seen by numeral 63′, via the processor to match the start time at which the valve assembly transitions from one state to another state. The process may include determining the volume of said fluid passing through valve assembly during a transition between valve states based on i) the valve closure pattern, ii) the actuation duration of the valve assembly from one state to another state, iii) a determination of the start time of said transition, and iv) a shifting of the valve closure pattern to match the start time.

The process may therefore include using one or more algorithms to estimate discharge and recirculation flow while valve assembly 30.1 is changing position. The process may include using the algorithm to more accurately determine one or more of: the discharge and recirculation flow rates 38.1 and 44.1 seen in FIG. 5 while the valve assembly is in transition between discharge and recirculation positions; the total discharge volume 40.1 while the valve assembly is in transition between the discharge and recirculation positions; and the total recirculation volume 46.1 while the valve assembly is in transition between the discharge and recirculation positions.

The process may include transforming valve closure pattern 63 via the processor based on a determination that the actuation duration of the valve assembly has increased due to wear and tear of the valve assembly.

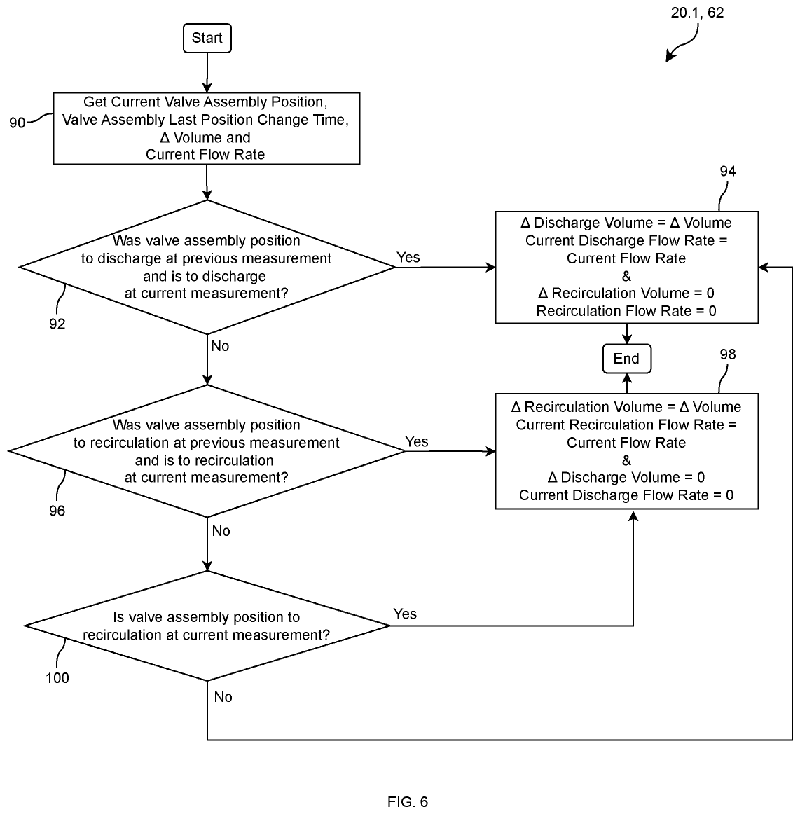

FIG. 6 illustrates a non-limiting algorithm/process or flow chart setting operation of software-based dynamic flow processor 62. The algorithm or process may be suitable for systems where the execution interval of the processor is longer than the duration of valve actuation and where the valve actuation is completed before the next measurement cycle begins. The process set out in FIG. 6 does not use or require dynamic simulation. As shown by box 90, the algorithm or process may include obtaining current valve assembly position, the start time at which of the valve assembly changed from the prior position to the current position and/or at which of the valve assembly last changed position, the change of volume passing through the flow meter and the current flow rate passing through the flow meter as has been described above.

As seen by box 92, the process may next include determining via processor 62 whether the current position of the valve assembly is the discharge position (via apparatus 80 seen in FIG. 5) and whether the valve assembly was in the discharge position in a previous measurement of the position of the valve assembly. If so and as shown by box 94, the processor determines that the change of volume of the fluid as determined by the single flow meter is the change of discharge volume and that the current flow rate of the fluid passing through the single flow meter is the current discharge flow rate.

If the processor determines (via apparatus 80 seen in FIG. 5) that the valve assembly is not currently in the discharge position (or at the current measurement) nor was the valve assembly in the discharge position in its previous measurement, then the process may include as shown by box 96: determining via the processor whether the current position of the valve assembly is the recirculation position and whether the valve assembly was in the recirculation position in the previous measurement of the position of the valve assembly. If so and as shown by box 98, the process may next include determining that the change of volume of the fluid as determined by the single flow meter is the change of recirculation volume and that the current flow rate of the fluid passing through the single flow meter is the current recirculation flow rate.

As shown by box 100, the process may include determining whether the current position of the valve assembly is the recirculation position and that the previous measurement of the position of the valve assembly was neither the discharge position nor the recirculation position. In addition or alternatively, box 100 of the process may comprising determining whether the valve assembly is currently in the recirculation position (or at the current measurement) and whether it was neither in the recirculation nor discharge positions in the previous measurement. If so and as shown by box 98, the process in this case determines that the change of volume of said fluid passing as determined by the single flow meter is the change of recirculation volume and that the current flow rate of said fluid passing through the single flow meter is the current recirculation flow rate.

If the process determines that the valve assembly is currently in the discharge position (or at the current measurement) and was neither in the recirculation nor discharge positions in the previous measurement, in this case and as shown by box 94, the process determines that the change of volume of said fluid is the change of discharge volume and that the current flow rate of said fluid is the current discharge flow rate. Alternatively, if the process determines that the valve assembly is not in the recirculation position at the current measurement and was neither in the recirculation nor discharge positions in the previous measurement, in this case and as shown by box 94, the process determines that the change of volume of said fluid as determined by the single flow meter is the change of discharge volume and that the current flow rate of said fluid passing through the single flow meter is the current discharge flow rate.

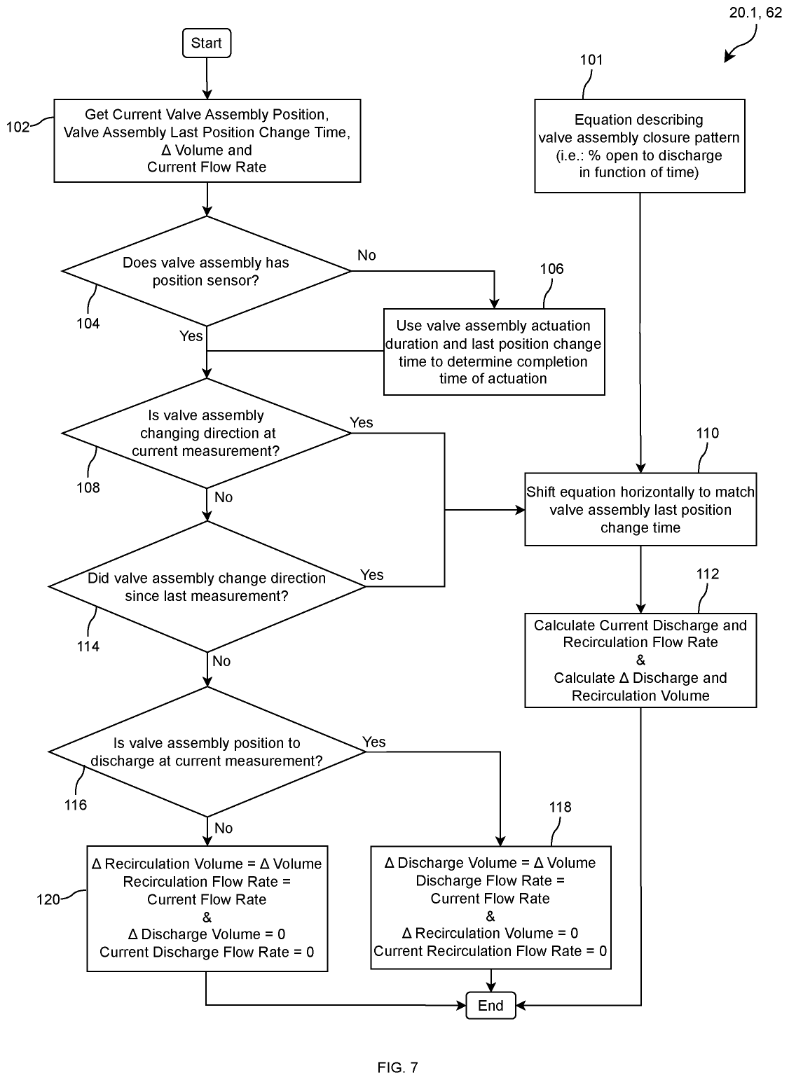

FIG. 7 illustrates another non-limiting algorithm/process or flow chart setting operation of software-based dynamic flow processor 62. The algorithm or process is suitable for any system, regardless of the relationship between the execution interval of the dynamic flow processor and the duration of valve actuation. The process set out in FIG. 7 may use dynamic simulation to improve the accuracy of the determinations of processor. As shown by box 101, the process includes an equation describing the valve closure pattern i.e. the percentage or extent to which the valve assembly is open to discharge as a function of time. As shown by box 102, the algorithm or process may next include obtaining current valve assembly position, the start time at which of the valve assembly changed from the prior position to the current position and/or at which of the valve assembly last changed position, the change of volume passing through the flow meter and the current flow rate passing through the flow meter as has been described above.

In one non-limiting embodiment and as shown by box 104, the process may next include determining via processor 62 whether the valve assembly includes a position sensor and/or valve sensor. If no and as shown by box 106, the process may include using actuation duration of the valve assembly and the start time or last position change time, to determine completion time of actuation.

The process may next include based on data from the position/valve sensor as seen by box 104, determining whether the valve assembly is changing direction at its current measurement as seen by box 108. In addition or alternatively, the process may include using the actuation duration of valve assembly, the start time and/or the completion time of actuation so determined of box 106, to determine occurrence of said changing direction at said current measurement.

If processor 62 determines that the valve assembly is changing direction at the current measurement of the position of the valve assembly, the process may include as seen by box 110: shifting the equation describing the valve closure pattern of the valve assembly (box 101) horizontally to match the start time of the change in direction. The process may include calculating the current discharge and recirculation flow rates based thereon (via mass balancing and correlating the valve closure pattern so time shifted with the current flow rate as determined by the single flow meter in real-time) and calculating the change in discharge and recirculation volume based thereon as shown by box 112 (via mass balancing and correlating of the valve closure pattern so time shifted with the change of volume passing through the single flow meter).

If the valve assembly is determined to not be changing direction at the current measurement of the position of the valve assembly, the process may next include determining via processor 62 whether the valve assembly has changed direction since a last measurement of the position of the valve assembly as shown by box 114. If so, the process may include shifting the equation describing the closure pattern of the valve assembly horizontally to match the start time as shown by box 110, followed by calculating the current discharge and recirculation flow rates and calculating the change in discharge and recirculation volume based thereon as shown by box 112 as mentioned above.

If the valve assembly is determined to not be changing direction at the current measurement nor to have changed direction since the last measurement of the position thereof, the process may next include as shown by box 116: determining via processor 62 whether the position of the valve assembly is the discharge position. If so and as seen by box 118: the process may include determining via the processor 62 the change of volume of said fluid passing through the single flow meter and/or valve assembly is equal to the change in discharge volume and determining that the current flow rate of said fluid as determined by the single flow meter and/or entering the valve assembly, is equal to the current discharge flow rate.

If the valve assembly is determined to not be changing direction at the current measurement nor to have changed direction since the last measurement of the position thereof and the valve assembly is determined not to be in the discharge position, the process may include as shown by box 120: determining that the change of volume of said fluid passing through the single flow meter and/or valve assembly is equal to the change in recirculation volume and determining that the current flow rate of said fluid passing through the single flow meter and/or entering the valve assembly, is equal to the current recirculation flow rate. Water monitoring and control system 20.1 (and related process thereof) as set out in FIG. 7 may thus function to improve accuracy of the estimation when valve assembly 30.1 (or one or more valves thereof) has changed position between the measurements. The water monitoring and control system as herein described thus functions to estimate outgoing (discharge and recirculation) flow and total (discharge and recirculation) volume.

Referring to FIGS. 5 to 7, water monitoring and control system 20.1 as herein described may be said to comprise a computer program product including a medium carrying computer readable instructions which, when executed by processor 62, cause the processor to execute one or more of the processes herein described. Referring to FIG. 5, server 88 as herein described may comprise said computer program product, with the server being configured to deliver the computer readable instructions to a recipient computer by a way of a communication medium. The terms “medium” and “program product” are intended to be non-limiting in scope and may comprise any transmission-type media.

Referring back to FIG. 4, there is also thus disclosed herein use of single flow meter 72 measuring in real-time fluid outputted from worksite 22.1, together with real-time measurement of positioning of valve assembly 30.1 via which the fluid is discharge or recirculated, for determining the discharge and recirculation flow rates 38.1 and 44.1 of the fluid, the total discharge volume 40.1 of said fluid and the total recirculation volume 46.1 of said fluid. The use may include in one non-limiting embodiment using one or more valve position sensors 80B seen in FIG. 5 to measure positioning of valve assembly.

The use may include using start time 61 of a change in valve positioning seen in FIG. 8 and actuation duration of valve assembly 30.1 to determine a competition time of actuation. The use may include using the start time of the change in valve positioning, valve closure pattern 63 and shifting of the valve closure pattern 63′ to match the start time so as to better determine the discharge and recirculation flow rates 38.1 and 44.1 of the fluid, the total discharge volume 40.1 of said fluid and the total recirculation volume 46.1 of said fluid seen in FIG. 5.

The use may include using processor 62 configured to receive valve positioning data together with data from single flow meter 72, and based thereon determine the discharge and recirculation flow rates of the fluid, the total discharge volume of said fluid and the total recirculation volume of said fluid.

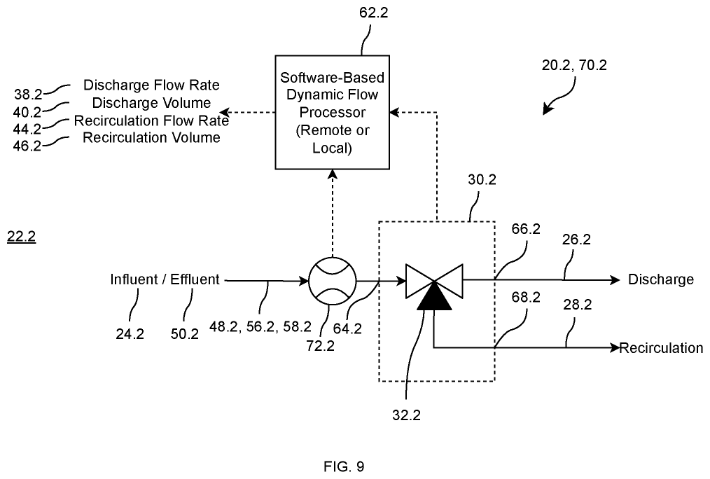

FIG. 9 shows a water monitoring and control system 20.2 according to another aspect. Like parts have like numbers and functions as water monitoring and control system 20.1 shown in FIGS. 2 to 8 with decimal extension “0.2” replacing decimal extension “0.1” and being added for parts not previously having a decimal extension. Water monitoring and control system 20.2 is substantially the same as water monitoring and control system 20.1 shown in FIGS. 2 to 8 with the exception that valve assembly 30.2 in this non-limiting embodiment comprises a three-way valve 32.2.

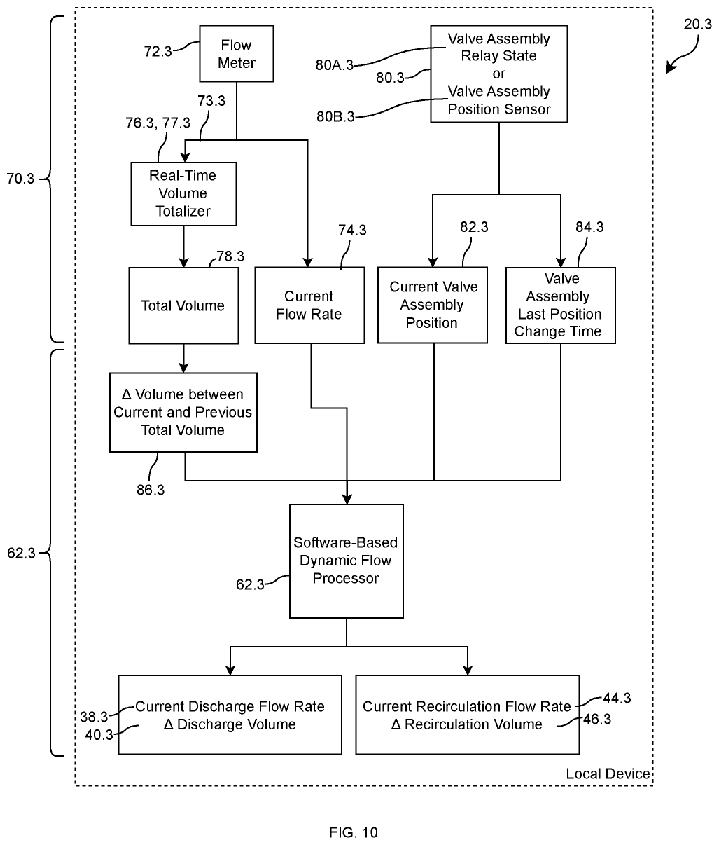

FIG. 10 shows a water monitoring and control system 20.3 according to a further aspect. Like parts have like numbers and functions as water monitoring and control system 20.1 shown in FIGS. 2 to 8 with decimal extension “0.3” replacing decimal extension “0.1” and being added for parts not previously having a decimal extension. Water monitoring and control system 20.3 is substantially the same as water monitoring and control system 20.1 shown in FIGS. 2 to 8 with at least the following exceptions.

Dynamic flow processor 62.3 in this non-limiting embodiment is locally situated and/or on-site. The flow processor may be a third party said processor and/or a part of the water monitoring and control system 20.3. In addition or as a further alternative, the processor may be a part of the controller via which the valve assembly of the water monitoring and control system is selectively actuated.

It will be appreciated that many variations are possible within the scope of the invention described herein.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value÷10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments” Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

### ADDITIONAL DESCRIPTION

Examples of water monitoring and control systems and processes have been described. The following clauses are offered as further description.
(1) A water monitoring and control system comprising: a flow meter configured to measure fluid outputted from a worksite; a valve assembly including an inlet in fluid communication with the flow meter, a discharge outlet and a recirculation outlet; discharge and recirculation conduits in fluid communication with respective ones of said outlets of the valve assembly; an apparatus which outputs an indication of valve positioning of the valve assembly; and a processor in communication with the flow meter and the apparatus and configured based thereon to determine discharge and recirculation flow rates of said fluid through the discharge and the recirculation conduits, a total discharge volume of said fluid passing through the discharge conduit and a total recirculation volume of said fluid passing through the recirculation conduit.
(2) A water monitoring and control system comprising: a flow meter configured to measure fluid outputted from a worksite; a valve assembly including an inlet in fluid communication with the flow meter, and discharge and recirculation outlets selectively in communication with the inlet thereof based on valve positioning thereof; discharge and recirculation conduits in fluid communication with the discharge and recirculation outlets, respectively; an apparatus which outputs an indication of the valve positioning of the valve assembly; and a processor configured to determine the flow rates and total volume of the fluid passing through the discharge and recirculation conduits based on: said valve positioning as indicated by said apparatus, the flow rate of fluid passing through the flow meter and the incremental volume of fluid passing through the flow meter.
(3) A water monitoring and control system of any clause herein, wherein the apparatus comprise a valve position sensing device.
(4) A water monitoring and control system of any clause herein, wherein the apparatus comprises one or more valve sensors.
(5) A water monitoring and control system of any clause herein, wherein the apparatus comprises a relay activation of which controls and/or adjusts positioning of the valve assembly.
(6) A water monitoring and control system of any clause herein, wherein data indicative of said valve positioning is obtained in real-time based on the apparatus.
(7) A water monitoring and control system of any clause herein, wherein the flow meter is upstream of the valve assembly.
(8) A water monitoring and control system of any clause herein, wherein the valve assembly comprises one or more solenoid valves.
(9) A water monitoring and control system of any clause herein, wherein the valve assembly comprises a three-way valve.
(10) A water monitoring and control system of any clause herein, wherein the valve assembly comprises a first valve in fluid communication with the discharge conduit and a second valve in fluid communication with the recirculation conduit.
(11) A water monitoring and control system of any clause herein, wherein the system consists of one said flow meter.
(12) A water monitoring and control system of any clause herein, wherein the system comprises a dynamic said flow meter.
(13) A water monitoring and control system of any clause herein, wherein the system comprises a dynamic flow said processor.
(14) A water monitoring and control system of any clause herein, wherein the fluid comprises one or more of effluent, influent, runoff and wastewater.
(15) A water monitoring and control system of any clause herein, wherein the flow meter is configured to be positioned downstream of a water treatment system.
(16) A water monitoring and control system of any clause herein, wherein the flow meter is configured to be interposed between the valve assembly and the water treatment system.
(17) A water monitoring and control system of any clause herein, wherein the processor determines approximations of the discharge and recirculation flow rates, the total discharge volume and the total recirculation volume based on the valve positioning, an output flow rate of the water treatment system and the incremental volume of the flow meter so determined.
(18) A water monitoring and control system of any clause herein, wherein the system is configured to transmit data to a remote server via which is determined the discharge and recirculation flow rates, the total discharge volume and the total recirculation volume.
(19) A water monitoring and control system of any clause herein, wherein the data is acquired locally in real-time and transmitted to the remote server in intervals.
(20) A water monitoring and control system of any clause herein, wherein the data is transmitted to the remote server at predetermined intervals.
(21) A water monitoring and control system of any clause herein, wherein each said predetermined interval is substantially equal to about one minute.
(22) A water monitoring and control system of any clause herein, wherein the processor is off-site, wherein the system includes a remote data acquisition system configured to receive one or more signals or data from the flow meter and the apparatus locally and wherein the system includes a transceiver via which said one or more signals or data are communicated to the processor.
(23) A water monitoring and control system of any clause herein, wherein the processor is a part of a cloud computing system.
(24) A water monitoring and control system of any clause herein, wherein the processor is situated locally and/or on-site.
(25) A water monitoring and control system of any clause herein, including a controller via which the valve assembly is selectively actuated.
(26) A water monitoring and control system of any clause herein, wherein the controller comprises said processor.
(27) A water monitoring and control system of any clause herein, including an algorithm stored in memory thereof and which estimates the flow in each said conduit while the valve assembly is changing position.
(28) A water monitoring and control system of any clause herein, including a totalizer configured to measure a total accumulated volume of fluid passing through the flow meter.
(29) A water monitoring and control system of any clause herein, wherein the totalizer is configured to measure the volume of fluid passing through the flow meter in real-time.
(30) A water monitoring and control system of any clause herein, wherein the totalizer is configured to operate locally on the flow meter or on a controller of the valve assembly.
(31) A water monitoring and control system of any clause herein, wherein the data is fetched remotely with the totalizer being configured to accumulate the flow of said fluid passing the flow meter locally between each data fetch cycle.
(32) A water monitoring and control system of any clause herein, including a high-speed digital input counter to acquire volume information from the flow meter.
(33) A water monitoring and control system of any clause herein, wherein the high-speed digital input counter acquires volume information in the form of a volume per pulse.
(34) A water monitoring and control system of any clause herein, wherein the high-speed digital input counter operates in the range of 0 to 500 Hz.
(35) A water monitoring and control system of any clause herein, wherein the valve assembly is configured to direct the flow of said fluid between said conduits and/or from a first said conduit to a second said conduit and vice versa.
(36) A water monitoring and control system of any clause herein, wherein the valve assembly is configured to selectively i) promote passage of the fluid to the discharge conduit; ii) promote passage of the fluid to the recirculation conduit; or iii) inhibit passage of the fluid to either said conduit.
(37) A water monitoring and control system comprising: a flow meter configured to measure fluid outputted from a worksite; a valve assembly including an inlet in fluid communication with the flow meter and including a pair of outlets selectively in fluid communication with the inlet thereof; discharge and recirculation conduits in fluid communication with respective ones of said outlets of the valve assembly; and a data acquisition system configured to i) obtain data indicative in real-time of valve positioning, the flow rate of fluid passing through the flow meter and the incremental volume of fluid passing through the flow meter and ii) transmit said data to a processor from which is determined the flow rates and total volume of fluid passing through both said conduits.
(38) A water monitoring and control system according to any clause herein, wherein the data acquisition system is configured to periodically transmit said data to the processor at intervals.
(39) A water monitoring and control system according to any clause herein, wherein the processor is part of an off-site central server.
(40) A water monitoring and control system according to any clause herein, wherein the data acquisition system obtains said data locally and wherein the data is processed off-site.
(41) A water monitoring and control system according to any clause herein, wherein the processor is on-site.
(42) A water monitoring and control system according to any clause herein, wherein the fluid outputted from the worksite has an intermittent flow.
(43) A water monitoring and control system according to any clause herein, wherein the system is configured to operate receiving an intermittent flow of said fluid outputted from the worksite.
(44) A water monitoring and control system according to any clause herein, wherein the valve assembly has a valve closure pattern indicative of the extent to which the valve assembly is open to discharge fluid to the discharge conduit and/or the recirculation conduit as a function of time and wherein the processor incorporates said valve closure pattern at least in part in determining one or more of: the discharge and recirculation flow rates of said fluid through the discharge and the recirculation conduits, the total discharge volume of said fluid passing through the discharge conduit and the total recirculation volume of said fluid passing through the recirculation conduit.
(45) A water monitoring and control system according to any clause herein, wherein the valve closure pattern is determined via computational fluid dynamics simulations.
(46) A water monitoring and control system according to any clause herein, wherein the valve closure pattern is determined empirically via temporary use of a second said flow meter downstream of the valve assembly.
(47) A water monitoring and control system according to any clause herein, wherein the processor is configured to transform the valve closure pattern based on a determination that the actuation duration of the valve assembly has increased due to wear and tear of the valve assembly.
(48) A water monitoring and control system according to any clause herein, wherein the processor is configured to shift the valve closure pattern to match a start time at which the valve assembly transitions from one state to another state and/or from an open to a closed position or vice versa and/or from a discharge position to a recirculation position or vice versa.
(49) A water monitoring and control system according to any clause herein, including formulating an equation describing said valve closure pattern.
(50) A water monitoring and control system according to any clause herein, wherein the processor is configured to shift said equation horizontally to match the start time at which the valve assembly transitions from one state to another state and/or from an open to a closed position or vice versa and/or from a discharge position to a recirculation position or vice versa.
(51) A water monitoring and control system according to any clause herein, wherein the volume of said fluid passing through the valve assembly during a transition between valve states is determined based on the valve closure pattern and a determination of an actuation duration of the valve assembly.
(52) A water monitoring and control system according to any clause herein, wherein the volume of said fluid passing through the valve assembly during a transition between valve states is determined based on the valve closure pattern, an actuation duration of the valve assembly, a determination of a start time of said transition, and a shifting of the valve closure pattern to match the start time.
(53) A water monitoring and control system according to any clause herein, including one or more sensors configured to measure properties of the fluid in real-time, the one or more sensors being in communication with the processor and/or a controller, with the system via the processor and/or controller determining whether the fluid satisfies one or more predetermined conditions based thereon, and if so actuating the valve assembly to discharge the fluid from the worksite and if no, actuating the valve assembly to recirculate the fluid to the site.
(54) A water monitoring and control system comprising: a first conduit configured to receive fluid outputted from a worksite, a second conduit configured to discharge said fluid from the first conduit, and a third conduit configured to recirculate said fluid from the first conduit back towards the site; a valve assembly operatively connecting together the first and second conduits and the first and third conduits; and a processor which determines flow rates and total volume of the fluid passing through the second and third conduits, respectively, based on valve positioning and the flow rate and incremental flow of fluid passing through the first conduit.
(55) A water monitoring and control system according to any clause herein, wherein the valve positioning of the valve assembly is determined in real-time.
(56) A water monitoring and control system according to any clause herein, including and/or consisting of only a single flow meter.
(57) A water monitoring and control system according to any clause herein, wherein the single flow meter operatively connects to the first conduit, with the flow rate and incremental flow of fluid passing through the first conduit being measured via the single flow meter.
(58) A water monitoring and control system according to any clause herein, wherein the flow rate and the incremental flow of fluid passing through the first conduit are dynamic and measured in real-time.
(59) A water monitoring and control system consisting of: a first conduit configured to receive fluid outputted from a worksite; a flow meter operatively connected to the first conduit; a second conduit configured to discharge said fluid from the first conduit; a third conduit configured to recirculate said fluid from the first conduit back towards the site; a valve assembly operatively connecting together the first and second conduits and the first and third conduits; and an apparatus which outputs an indication of valve positioning of the valve assembly.
(60) A water monitoring and control system comprising: a first conduit configured to receive fluid outputted from a worksite, a second conduit configured to discharge said fluid from the first conduit, a third conduit configured to recirculate said fluid from the first conduit back towards the site, a valve assembly operatively connecting together the first and second conduits and the first and third conduits, and a measurement assembly via which data indicative of flow rates and total volume of fluid passing through each said conduit is obtained, the assembly comprising or consisting of i) a flow meter operatively connected to the first conduit; and ii) an apparatus which outputs an indication of valve positioning of the valve assembly.
(61) A water monitoring and control system comprising: a first conduit configured to receive fluid outputted from a worksite, a second conduit configured to discharge said fluid from the first conduit, a third conduit configured to recirculate said fluid from the first conduit back towards the site, a valve assembly operatively connecting together the first and second conduits and the first and third conduits, and a flow and volume assembly via which flow rates and total volume of fluid passing through each said conduit are determined, the assembly comprising or consisting of i) a flow meter operatively connected to the first conduit; ii) an apparatus which outputs an indication of valve positioning of the valve assembly; and iii) a processor in communication with said flow meter and said apparatus.
(62) A water monitoring and control system for fluid outputted from a worksite and which is discharged or recirculated via a valve assembly, the system comprising: a device configured to output data indicative in real-time of i) the total volume and the current flow rate of the fluid entering into and/or upstream of the valve assembly, ii) the current position of the valve assembly, and iii) a start time at which of the valve assembly changes from a prior position to the current position thereof; and a processor configured to receive said data and determine therefrom: the change in volume between the current and previous total volume of said fluid; the current discharge flow rate; the change in discharge volume; the current recirculation flow rate; and the change in recirculation volume.
(63) A water monitoring and control system according to any clause herein, wherein the device is locally situated.
(64) A water monitoring and control system according to any clause herein, wherein the processor is off-site and operates via remote and/or cloud-based software.
(65) A water monitoring and control system according to any clause herein, wherein the processor is locally situated.
(66) A water monitoring and control system according to any clause herein, wherein the flow meter includes a real-time volume totalizer via which the total volume of the fluid upstream of the valve assembly is obtained.
(67) A water monitoring and control system according to any clause herein, wherein the device outputs data indicative of the current position of the valve assembly and/or the start time at which of the valve assembly changes from the prior position to the current position thereof, based on one or more relay states of the valve assembly.
(68) A water monitoring and control system according to any clause herein, wherein the device outputs data indicative of the current position of the valve assembly and/or the start time at which of the valve assembly changes from the prior position to the current position thereof, based on one or more valve assembly position sensors.
(69) A water monitoring and control system according to any clause herein, wherein the device comprises said flow meter and/or said one or more valve assembly position sensors.
(70) A water monitoring and control system according to any clause herein, wherein the processor includes an execution interval, wherein the execution interval of the processor is longer than the duration of valve actuation, and wherein the valve actuation is completed before the next measurement cycle begins.
(71) A water monitoring and control system according to any clause herein, wherein the processor includes an execution interval, wherein the execution interval of the processor is shorter than the duration of valve actuation.
(72) A water monitoring and control system according to any clause herein, wherein the water monitoring and control system is configured to function regardless of the relationship between an execution interval of the processor and duration of valve actuation.
(73) A water monitoring and control system comprising discharge and recirculation conduits with a valve or valve assembly positioned therebetween, a single flow meter positioned upstream of said valve or valve assembly, and a processor which determines the flow rate and total volume of both said conduits based on valve position, flow rate from the flow meter and the incremental volume of the flow meter.
(74) A water monitoring and control system according to any clause herein, wherein the valve assembly includes a high frequency of valve switching and/or actuation.
(75) A water monitoring and control system according to any clause herein, wherein the rate of acquisition of water quality data and/or valve positioning data of the valve assembly is configured to be equal to or greater than the frequency of valve switching and/or actuation of the valve assembly.
(76) A water monitoring and control system according to any clause herein, wherein the rate of acquisition of water quality data and/or valve positioning data of the valve assembly is configured to be greater than the frequency of valve switching and/or actuation of the valve assembly.
(77) A water monitoring and control system according to any clause herein, wherein the flow meter is configured to be capable of operating locally at one or more frequencies higher than the frequency at which the processor is executed.
(78) A water monitoring and control system according to any clause herein, wherein the totalizer is configured to be capable of operating locally at one or more frequencies higher than the frequency at which the processor is executed.
(79) A water monitoring and control system according to any clause herein, including: a flow meter configured to obtain said flow rate of fluid and said incremental volume of fluid outputted from the worksite in real-time; a valve position sensor or relay via which positioning of the valve assembly is obtained in real-time; and a processor configured to i) obtain said data, ii) obtain or determine valve position as a function of time based thereon, iii) correlate the flow rate of fluid obtained by the flow meter with valve position to determine discharge and recirculation flow rates as a function of time, and iv) correlate the incremental volume with valve position as a function of time and sum said incremental volume of fluid so correlated to determine said total discharge and recirculation volumes for a given time period.
(80) In combination, a water treatment system and a water monitoring and control system of any clause herein operatively connected thereto.
(81) A water monitoring and control process comprising: monitoring fluid outputted from a worksite, determining whether said fluid satisfies one or more predetermined conditions and based thereon, actuating a valve assembly to either discharge the fluid from the worksite or recirculate the fluid to the worksite; obtaining data indicative in real-time of valve positioning of the valve assembly, the flow rate of said fluid via a flow meter upstream of the valve assembly, and the incremental volume of fluid passing through the flow meter; and determining via a processor and based on said data, discharge and recirculation flow rates and the total volume of discharge and recirculation of said fluid.
(82) A water monitoring and control process according to any clause herein, including within the determining whether said fluid satisfies one or more predetermined conditions step, measuring one or more properties of the fluid in real-time via one or more sensors.
(83) A water monitoring and control process comprising: discharging fluid from a worksite which satisfies one or more predetermined conditions via a valve assembly; recirculating fluid to the worksite which fails to satisfy the one or more predetermined conditions via the valve assembly; obtaining data in real-time indicative of valve positioning of the valve assembly, the flow rate of said fluid upstream of the valve assembly via a flow meter and the incremental volume of fluid passing through the flow meter; and determining via a processor and based on said data, discharge and recirculation flow rates and the total volume of discharge and recirculation of said fluid.
(84) A water monitoring and control process according to any clause herein, including obtaining the data indicative of the valve positioning via one or more valve position sensing devices.
(85) A water monitoring and control process according to any clause herein, including obtaining the data indicative of the valve positioning via one or more valve sensors.
(86) A water monitoring and control process according to any clause herein, including obtaining the data indicative of the valve positioning based one or more relays, activation of which causes positioning of the valve assembly to be adjusted.
(87) A water monitoring and control process according to any clause herein, wherein the valve assembly comprises one or more solenoid valves.
(88) A water monitoring and control process according to any clause herein, wherein the valve assembly comprises a three-way valve.
(89) A water monitoring and control process according to any clause herein, wherein the valve assembly comprises a first valve actuation of which enables discharging of the fluid from the worksite and wherein the valve assembly comprises a second valve actuation of which promotes recirculation of the fluid to the worksite.
(90) A water monitoring and control process according to any clause herein, comprising relying solely on one said flow meter upstream of the valve assembly, together with said valve positioning, to determine the discharge and recirculation flow rates and the total volume of discharge and recirculation of said fluid.
(91) A water monitoring and control process according to any clause herein, including providing a dynamic said flow meter.
(92) A water monitoring and control process according to any clause herein, including providing a dynamic flow said processor.
(93) A water monitoring and control process according to any clause herein, wherein the fluid comprises one or more of effluent, influent, runoff and wastewater.
(94) A water monitoring and control process according to any clause herein, including positioning the flow meter downstream of a water treatment system.
(95) A water monitoring and control process according to any clause herein, including interposing the flow meter between the water treatment system and the valve assembly.
(96) A water monitoring and control process according to any clause herein, including transmitting said data to the processor.
(97) A water monitoring and control process according to any clause herein, including transmitting said data to a remote server via which is determined the discharge and recirculation flow rates, the total discharge volume and the total recirculation volume.
(98) A water monitoring and control process according to any clause herein, including acquiring said data locally in real-time and transmitting said data to the remote server in intervals for processing thereof.
(99) A water monitoring and control process according to any clause herein, wherein the processor is situated locally and on-site.
(100) A water monitoring and control process according to any clause herein, wherein the processor is off-site.
(101) A water monitoring and control process according to any clause herein, wherein the processor is part of a cloud computing system.
(102) A water monitoring and control process according to any clause herein, including actuating the valve assembly via a controller, with the controller comprising said processor.
(103) A water monitoring and control process according to any clause herein, including using an algorithm to estimate discharge and recirculation flow while the valve assembly is changing position.
(104) A water monitoring and control process of any clause herein, including using said algorithm to more accurately determine one or more of: the discharge and recirculation flow rates while the valve assembly is in transition between discharge and recirculation positions; the total discharge volume while the valve assembly is in transition between the discharge and recirculation positions; and the total recirculation volume while the valve assembly is in transition between the discharge and recirculation positions.
(105) A water monitoring and control process according to any clause herein, including measuring the total accumulated volume of said fluid passing through the flow meter via a totalizer.
(106) A water monitoring and control process of any clause herein, including fetching said data remotely with the totalizer being configured locally to accumulate the flow of said fluid passing the flow meter between each data fetch cycle.
(107) A water monitoring and control process of any clause herein, including acquiring volume information from the flow meter via a high-speed digital input counter.
(108) A water monitoring and control process of any clause herein, including acquiring the volume information via the high-speed digital input counter in the form of a volume per pulse.
(109) A water monitoring and control process of any clause herein, including operating the high-speed digital input counter in the range of 0 to 500 Hz.
(110) A water monitoring and control process of any clause herein, including configuring the valve assembly to direct the flow of said fluid between recirculation and discharge conduits or from a first said conduit to a second said conduit and vice versa.
(111) A water monitoring and control process comprising: measuring fluid outputted from a worksite via a flow meter; selectively discharging or recirculating said fluid via a valve assembly downstream of the flow meter; acquiring data indicative in real-time of valve positioning, the flow rate of said fluid passing through the flow meter and the incremental volume of said fluid passing through the flow meter; and determining discharge and recirculation flow rates and the total volume of discharge and recirculation of said fluid based on said data.
(112) A water monitoring and control process according to any clause herein, including determining via one or more sensors whether said fluid satisfies one or more predetermined conditions and based thereon, selectively discharging or recirculating said fluid. A water monitoring and control process according to any clause herein, including transmitting said data to the processor.
(113) A water monitoring and control process according to any clause herein, including periodically transmitting said data obtained in real-time to the processor.
(114) A water monitoring and control process according to any clause herein, including transmitting said data to an off-site central server for processing and/or storage thereof.
(115) A water monitoring and control process according to any clause herein, including obtaining said data locally and processing and/or storing said data off-site.
(116) A water monitoring and control process according to any clause herein, wherein the fluid outputted from the worksite has an intermittent flow.
(117) A water monitoring and control process according to any clause herein, including incorporating a valve closure pattern of the valve assembly at least in part in determining one or more of: the discharge and recirculation flow rates, the total discharge volume of said fluid and the total recirculation volume of said fluid.
(118) A water monitoring and control process according to any clause herein, wherein the valve closure pattern is indicative of the extent to which the valve assembly is open to discharge fluid as a function of time.
(119) A water monitoring and control process according to any clause herein, wherein the valve closure pattern is indicative of the extent to which the valve assembly is open to discharge fluid as a function of time while the valve assembly moves from discharge to recirculate positions or vice versa.
(120) A water monitoring and control process according to any clause herein, including determining the valve closure pattern via computational fluid dynamics simulations.
(121) A water monitoring and control process according to any clause herein, including determining the valve closure pattern empirically via temporary use of a second said flow meter downstream of the valve assembly.
(122) A water monitoring and control process according to any clause herein, wherein the valve assembly has an actuation duration and wherein the process includes transforming the valve closure pattern via the processor based on a determination that the actuation duration of the valve assembly has increased due to wear and tear of the valve assembly.
(123) A water monitoring and control process according to any clause herein, including shifting the valve closure pattern via the processor to match a start time at which the valve assembly transitions from one state to another state.
(124) A water monitoring and control process according to any clause herein, including formulating an equation describing said valve closure pattern.
(125) A water monitoring and control process according to any clause herein, including shifting said equation horizontally via the processor to match the start time at which the valve assembly transitions from one state to another state.
(126) A water monitoring and control process according to any clause herein, including determining the volume of said fluid passing through the valve assembly during a transition between valve states based on the valve closure pattern and a determination of the actuation duration of the valve assembly.
(127) A water monitoring and control process according to any clause herein, including determining the volume of said fluid passing through the valve assembly during a transition between valve states based on i) the valve closure pattern, ii) an actuation duration of the valve assembly from one state to another state, iii) a determination of the start time of said transition, and iv) a shifting of the valve closure pattern to match the start time.
(128) A water monitoring and control process according to any clause herein, including using mass balancing at least in part to determine discharge and recirculation flow rates.
(129) A water monitoring and control process according to any clause herein, including measuring only one upstream said flow rate to determine two downstream said flow rates.
(130) A water monitoring and control process for fluid outputted from a worksite and which is discharged or recirculated via a valve assembly, the process comprising: obtaining in real-time the current position of the valve assembly, the change of volume of the fluid passing through the valve assembly and the current flow rate of the fluid entering the valve assembly; determining via a processor whether the current position of the valve assembly is a discharge position and whether the valve assembly was in the discharge position in a previous measurement of the position of the valve assembly and if so, determining that the change of volume of the fluid is the change of discharge volume and that the current flow rate of the fluid is the current discharge flow rate; and determining via the processor whether the current position of the valve assembly is a recirculation position and whether the valve assembly was in the recirculation position in the previous measurement of the position of the valve assembly and if so, determining that the change of volume of the fluid is the change of recirculation volume and that the current flow rate of the fluid is the current recirculation flow rate.
(131) A water monitoring and control process according to any clause herein, including within the obtaining step, obtaining the start time at which of the valve assembly changed from the prior position to the current position.
(132) A water monitoring and control process according to any clause herein, including: determining whether the current position of the valve assembly is the recirculation position and that the previous measurement of the position of the valve assembly was neither the discharge position nor the recirculation position and if so, determining that the change of volume of said fluid is the change of recirculation volume and that the current flow rate of said fluid is the current recirculation flow rate and if no, determining that the change of volume of said fluid is the change of discharge volume and that the current flow rate of said fluid is the current discharge flow rate.
(133) A water monitoring and control process for fluid outputted from a worksite and which is discharged or recirculated via a valve assembly, the process comprising: i) obtaining in real-time a) the position of the valve assembly, b) a start time at which of the valve assembly last changed position, c) the change of volume of said fluid passing through the valve assembly and d) the current flow rate of said fluid entering the valve assembly; and ii) determining whether the valve assembly is changing direction at the current measurement of the position of the valve assembly and a) if so, shifting an equation describing a closure pattern of the valve assembly horizontally to match the start time and b) if the valve assembly is determined to not be changing direction at the current measurement of the position of the valve assembly, determining whether the valve assembly has changed direction since a last measurement of the position of the valve assembly and if so, shifting the equation describing the closure pattern of the valve assembly horizontally to match the start time, and c) calculating the current discharge and recirculation flow rates and calculating the change in discharge and recirculation volume based thereon.
(134) A water monitoring and control process according to any clause herein, including: iii) if the valve assembly is determined to not be changing direction at the current measurement nor to have changed direction since the last measurement of the position thereof, determining whether the position of the valve assembly is a discharge position and a) if so, determining that the change of volume of said fluid passing through the valve assembly is equal to the change in discharge volume and determining that the current flow rate of said fluid entering the valve assembly is equal to the current discharge flow rate; and b) if no, determining that the change of volume of said fluid passing through the valve assembly is equal to the change in recirculation volume and determining that the current flow rate of said fluid entering the valve assembly is equal to the current recirculation flow rate.
(135) A water monitoring and control process according to any clause herein, including within the determining whether the valve assembly is changing direction steps, using a position sensor to so determine.
(136) A water monitoring and control process according to any clause herein, including within the determining whether the valve assembly is changing direction steps, using a valve actuation duration and the start time to determine a completion time of actuation and occurrence of said changing direction.
(137) A water monitoring and control process according to any clause herein, including within the determining whether the valve assembly is changing direction steps, determining whether the valve assembly includes a position sensor and if no, using an actuation duration of the valve assembly and the start time to determine a completion time of actuation and occurrence of said changing direction.
(138) A water monitoring and control process according to any clause herein, wherein said determinations occur via a processor.
(139) A water monitoring and control process according to any clause herein, wherein the process is configured for where an execution interval of the processor is longer than the duration of valve actuation, with the valve actuation being completed before the next measurement cycle begins.
(140) A water monitoring and control process according to any clause herein, wherein the process is configured to be used for where an execution interval of the processor to be shorter than the duration of valve actuation.
(141) A water monitoring and control process according to any clause herein, wherein the process is configured to be used for any system regardless of the relationship between an execution interval of the processor and duration of valve actuation.
(142) A water monitoring and control system or process of any clause herein, wherein the worksite is a development or construction site.
(143) Use of a single flow meter measuring in real-time fluid outputted from a worksite, together with real-time measurement of positioning of a valve assembly via which the fluid is discharge or recirculated, for determining discharge and recirculation flow rates of the fluid, a total discharge volume of said fluid and a total recirculation volume of said fluid.
(144) The use of any clause herein, including using one or more valve position sensors to measure positioning of the valve assembly.
(145) The use of any clause herein, including using a start time of a change in valve positioning and an actuation duration of the valve assembly to determine a competition time of actuation.
(146) The use of any clause herein, including using a start time of a change in valve positioning, a valve closure pattern and a shifting of the valve closure pattern to match the start time so as to better determine the discharge and recirculation flow rates of the fluid, the total discharge volume of said fluid and the total recirculation volume of said fluid.
(147) The use of any clause herein, including using a processor configured to receive valve positioning data together with data from the single flow meter, and based thereon determine the discharge and recirculation flow rates of the fluid, the total discharge volume of said fluid and the total recirculation volume of said fluid.
(148) A water monitoring and control system or process according to any clause herein for use in construction discharge monitoring.
(149) A water monitoring and control system or process according to any clause herein for use in construction discharge monitoring involving a high frequency of valve switching relative to data acquisition rate and an intermittent incoming flow.
(150) A computer program product comprising a medium carrying computer readable instructions which, when executed by a processor, cause the processor to execute a process according to any clause herein.
(151) A server comprising a computer program product according to any clause herein, the server being configured to deliver the computer readable instructions to a recipient computer by a way of a communication medium.
(152) Apparatus including any new and inventive feature, combination of features, or sub-combination of features as described herein.
(153) Methods including any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A water monitoring and control system comprising:
a valve assembly configured to receive fluid outputted from a worksite and either recirculate or discharge the fluid based on whether the fluid satisfies one or more predetermined conditions; and
a data acquisition system configured to obtain data indicative in real-time of valve positioning, the flow rate of fluid outputted from the worksite and the incremental volume of fluid outputted from the worksite, with discharge and recirculation flow rates and total discharge and recirculation volumes being determinable therefrom.

2. A water monitoring and control system according to claim 1, including:
a flow meter configured to obtain said flow rate of fluid and said incremental volume of fluid outputted from the worksite in real-time;
a valve position sensor or relay via which positioning of the valve assembly is obtained in real-time; and
a processor configured to
i) obtain said data,
ii) obtain or determine valve position as a function of time based thereon,
iii) correlate the flow rate of fluid obtained by the flow meter with valve position to determine discharge and recirculation flow rates as a function of time, and
iv) correlate the incremental volume with valve position as a function of time and sum said incremental volume of fluid so correlated to determine said total discharge and recirculation volumes for a given time period.

3. A water monitoring and control system according to claim 1, including one or more of: wherein the data acquisition system includes a flow meter upstream of the valve assembly, with the data indicative of the flow rate of fluid outputted from the worksite and the incremental volume of fluid outputted from the worksite being obtained via said flow meter; and wherein the data acquisition system includes a valve positioning sensor or one or more relays activation of which causes actuation of the valve assembly, with the data indicative of the valve positioning being obtained thereby.

4. A water monitoring and control system of claim 1, including one or more of: the system includes a flow meter with a totalizer; the totalizer is configured to measure a total accumulated volume of fluid passing through the flow meter in real-time; the totalizer is configured to operate locally on the flow meter or on a controller of the valve assembly; the data is fetched remotely with the totalizer being configured to accumulate the flow of said fluid passing the flow meter locally between each data fetch cycle; the system includes a high-speed digital input counter to acquire volume information from the flow meter; the high-speed digital input counter acquires volume information from the flow meter in the form of a volume per pulse; and the high-speed digital input counter operates in the range of 0 to 500 Hz.

5. A water monitoring and control system of claim 1, wherein one or more of: wherein the system includes a processor to which said data is transmitted and via which is determined the discharge and recirculation flow rates and the total discharge and recirculation volumes; the system is configured to operate receiving an intermittent flow of said fluid outputted from the worksite; the system comprises a flow meter and a dynamic flow said processor; and the fluid comprises one or more of effluent, influent, runoff and wastewater.

6. A water monitoring and control system of claim 1, wherein one or more of: the data acquisition system is configured to obtain said data locally; the system includes a transceiver via which the data is communicated to a processor; the data is processed off-site at least in part; the processor is a part of a cloud computing system; the data is transmitted to the processor in intervals; and the data is stored off-site.

7. A water monitoring and control system according to claim 1, wherein the valve assembly has a valve closure pattern indicative of the extent to which the valve assembly is open to discharge or recirculate fluid as a function of time and wherein a processor incorporates said valve closure pattern at least in part in determining one or more of: the discharge and recirculation flow rates, the total discharge volume and the total recirculation volume.

8. A water monitoring and control system according to claim 1, including one or more of: wherein a processor is configured to formulate or receive an equation describing a valve closure pattern of the valve assembly and shift said equation horizontally to match a start time at which the valve assembly transitions from a discharge position to a recirculation position or vice versa; and wherein the volume of said fluid passing through the valve assembly during a transition between said positions is determined based on the valve closure pattern, an actuation duration of the valve assembly, a determination of the start time of said transition, and said shifting of the valve closure pattern to match the start time.

9. A water monitoring and control system according to claim 8, wherein the processor is configured to transform the valve closure pattern based on a determination that the actuation duration of the valve assembly has increased due to wear and tear of the valve assembly.

10. A water monitoring and control system according to claim 1, including one or more sensors configured to measure properties of the fluid in real-time, the one or more sensors being in communication with a processor, with the system via the processor determining whether the fluid satisfies said one or more predetermined conditions based thereon, and if so actuating the valve assembly to discharge the fluid from the worksite and if no, actuating the valve assembly to recirculate the fluid to the worksite.

11. A water monitoring and control system according to claim 1,
wherein the data acquisition system is configured to output data indicative in real-time of
i) the total volume and the current flow rate of the fluid entering into the valve assembly,
ii) the current position of the valve assembly, and
iii) a start time at which of the valve assembly changed from a prior position to the current position thereof; and
wherein a processor is configured to receive said data and determine therefrom:
i) the change in volume between the current and previous total volume of said fluid;
ii) the current discharge flow rate;
iii) the change in discharge volume;
iv) the current recirculation flow rate; and
v) the change in recirculation volume.

12. A water monitoring and control process using the water monitoring and control system of claim 1, the process comprising:
discharging said fluid from the worksite which satisfies said one or more predetermined conditions via the valve assembly and recirculating fluid to the worksite which fails to satisfy said one or more predetermined conditions via the valve assembly;
obtaining data in real-time indicative of valve positioning of the valve assembly, the flow rate of said fluid upstream of the valve assembly via a flow meter and the incremental volume of fluid passing through the flow meter; and
using said data to determine the discharge and recirculation flow rates and the total volume of discharge and recirculation of said fluid.

13. A computer program product comprising a medium carrying computer readable instructions which, when executed by a processor, cause the processor to execute a process according to claim 12 and/or a server comprising said computer program product, with the server being configured to deliver the computer readable instructions to a recipient computer by a way of a communication medium.

14. A water monitoring and control process according to claim 12, including one or more of:
monitoring the fluid outputted from the worksite;
measuring one or more properties of the fluid outputted from the worksite in real-time via one or more sensors; and
determining whether said fluid satisfies said one or more predetermined conditions and based thereon, actuating the valve assembly to either discharge the fluid from the worksite or recirculate the fluid to the worksite.

15. A water monitoring and control process according to claim 12, including obtaining the data indicative of the valve positioning via one or more of:
a valve position sensing apparatus;
a valve sensor; and
a relay activation of which causes positioning of the valve assembly to be adjusted.

16. A water monitoring and control process according to claim 12, including determining the volume of said fluid passing through the valve assembly during a transition between valve states based on i) a valve closure pattern of the valve assembly, ii) an actuation duration of the valve assembly from one state to another state, iii) a determination of the start time of said transition, and iv) a shifting of the valve closure pattern to match the start time.

17. A water monitoring and control process according to claim 12, including one or more of:
using mass balancing at least in part to determine discharge and recirculation flow rates; and
measuring only one upstream said flow rate to determine two downstream said flow rates.

18. A water monitoring and control process for fluid outputted from a worksite and which is discharged or recirculated via a valve assembly, the process comprising:
obtaining in real-time a current position of the valve assembly, a change of volume of the fluid passing through the valve assembly and a current flow rate of the fluid entering the valve assembly;
determining via a processor whether the current position of the valve assembly is a discharge position and whether the valve assembly was in the discharge position in a previous measurement of the position of the valve assembly and if so, determining that the change of volume of the fluid passing through the valve assembly is a change of discharge said volume and that the current flow rate of the fluid entering the valve assembly is the current discharge said flow rate; and
determining via the processor whether the current position of the valve assembly is a recirculation position and whether the valve assembly was in the recirculation position in the previous measurement of the position of the valve assembly and if so, determining that the change of volume of the fluid passing through the valve assembly is the change of recirculation said volume and that the current flow rate of the fluid entering the valve assembly is the current recirculation said flow rate.

19. A water monitoring and control process according to claim 18, including:
determining whether the current position of the valve assembly is the recirculation position and that the previous measurement of the position of the valve assembly was neither the discharge position nor the recirculation position and if so, determining that the change of volume of said fluid passing through the valve assembly is the change of recirculation said volume and that the current flow rate of said fluid entering the valve assembly is the current recirculation said flow rate and if no, determining that the change of volume of said fluid passing through the valve assembly is the change of discharge said volume and that the current flow rate of said fluid entering the valve assembly is the current discharge said flow rate.

20. A water monitoring and control process for fluid outputted from a worksite and which is discharged or recirculated via a valve assembly, the process comprising:
i) obtaining in real-time
a) the position of the valve assembly,
b) a start time at which of the valve assembly last changed position,
c) the change of volume of said fluid passing through the valve assembly and
d) the current flow rate of said fluid entering the valve assembly;
ii) determining whether the valve assembly is changing direction at the current measurement of the position of the valve assembly and
a) if so, shifting an equation describing a closure pattern of the valve assembly horizontally to match the start time and
b) if the valve assembly is determined to not be changing direction at the current measurement of the position of the valve assembly, determining whether the valve assembly has changed direction since a last measurement of the position of the valve assembly and if so, shifting the equation describing the closure pattern of the valve assembly horizontally to match the start time, and
c) calculating the current discharge and recirculation flow rates and calculating the change in discharge and recirculation volume based thereon; and
iii) if the valve assembly is determined to not be changing direction at the current measurement nor to have changed direction since the last measurement of the position thereof, determining whether the position of the valve assembly is a discharge position and
a) if so, determining that the change of volume of said fluid passing through the valve assembly is equal to the change in discharge said volume and determining that the current flow rate of said fluid entering the valve assembly is equal to the current discharge said flow rate; and
b) if no, determining that the change of volume of said fluid passing through the valve assembly is equal to the change in recirculation said volume and determining that the current flow rate of said fluid entering the valve assembly is equal to the current recirculation said flow rate.
